(19) United States
(12) Patent Application Publication
(10) Pub. No.: US 2025/0293844 A1
(43) Pub. Date: Sep. 18, 2025

(54) METHOD RELATED TO INTER-CELL BEAM OPERATION, USER EQUIPMENT, AND NETWORK DEVICE

(71) Applicant: SHARP KABUSHIKI KAISHA, Sakai City, Osaka (JP)

(72) Inventors: MEI-JU SHIH, Taipei (TW); CHIA-HUNG LIN, Taipei (TW); WAN-CHEN LIN, Taipei (TW); HUNG-CHEN CHEN, Taipei (TW)

(21) Appl. No.: 18/861,328

(22) PCT Filed: Apr. 28, 2023
(86) PCT No.: PCT/CN2023/091838

§ 371 Date: Oct. 29, 2024

Related U.S. Application Data
(60) Provisional application No. 63/336,944, filed on Apr. 29, 2022.

(51) Int. Cl. H04L 5/00

(52) U.S. Cl. CPC H04L 5/0094; H04L 5/0048; H04L 5/0053

(57) ABSTRACT

A method, a user equipment (UE), and a network device for an inter-cell beam operation are provided. The UE receives a radio resource control (RRC) message from a first cell and applies at least one of a transmission configuration indicator (TCI) configuration, a reference signal (RS) configuration associated with the TCI configuration, and a first value of control resource set (CORESET) pool indices to perform a transmission or a reception with a second cell. The RRC message includes first information including at least one of the TCI configuration, the RS configuration associated with the TCI configuration, and the first value of the CORESET pool indices. The first information is associated with the second cell having a second physical cell identity (PCI) that is different from a first PCI of the first cell.

### CROSS-REFERENCE TO RELATED APPLICATION(S)

The present application is a National Stage Application of International Patent Application Serial No. PCT/CN2023/091838, filed on Apr. 28, 2023, which claims the benefit of and priority to U.S. Provisional Patent Application Ser. No. 63/336,944, filed on Apr. 29, 2022, the contents of all of which are hereby incorporated herein fully by reference in their entirety for all purposes.

### TECHNICAL FIELD

The present disclosure generally relates to wireless communications, and more particularly, to a method related to inter-cell beam operation, user equipment, and network device.

### BACKGROUND

With the tremendous growth in the number of connected devices and the rapid increase in user/network traffic volume, various efforts have been made to improve different aspects of wireless communication for the next-generation wireless communication system, such as the fifth generation (5G) New Radio (NR), by improving data rate, latency, reliability, and mobility. The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC).

Multi-Input Multi-Output (MIMO) is one of the key technologies in 5G systems to achieve the high data rate and fulfill the requirement of enhanced Mobile Broad Band (eMBB). Moreover, MIMO technique is successful in commercial deployment. MIMO features are investigated and specified for both FDD and TDD systems, of which major parts were for downlink MIMO operation. In addition, it is important to enhance the uplink MIMO, while necessary enhancements on downlink MIMO that facilitate the use of large antenna array, not only for FR1 but also for FR2, would still need to be introduced to fulfil the request for evolution of NR deployments.

Multi Transmission and Reception Point (Multi-TRP, mTRP) was introduced to enhance the massive MIMO. Moreover, mTRP feature can improve the reliability, coverage, and capacity performance through flexible deployment scenarios. In the mTRP operation, the base station can communicate with the UE through multiple TRPs. Note that each TRP may be associated with a cell, a specific Sounding Reference Signal (SRS) resource set, a specific Radio Resource Control (RRC) parameter (i.e., CORESETPoolIndex), and/or a specific Transmission Configuration Indication (TCI) state. Note that a TCI state may include parameters for configuring a Quasi Co-Location (QCL) relationship between one or two Downlink (DL) reference signals and a target reference signal set. For example, a target reference signal set may be the DeModulation Reference Signal (DMRS) ports of PDSCH) or Physical Downlink Control Channel (PDCCH).

When it comes to multi-beam operation, especially targeting at FR2, the unified TCI framework was introduced to facilitate the streamlined multi-beam operation and reduce the signaling overhead. The unified TCI framework is applied to single-TRP cases, but it is envisioned that the unified TCI framework will be applied to multi-TRP cases.

With the evolution of MIMO techniques, the inter-cell mobility including the inter-cell beam management attracts attention. To reduce the latency and signaling overhead while achieving the high data rate, it is significant and necessary to study the inter-cell mobility especially in mTRP operation.

### SUMMARY

The present disclosure is directed to a method related to inter-cell beam operation, user equipment (UE), and network device.

According to one or more exemplary embodiments of the disclosure, a method related to inter-cell beam operation adapted for a UE is provided. The method includes, but is not limited to, receiving a radio resource control (RRC) message from a serving cell, applying at least one of transmission configuration indicator (TCI) configuration, a reference signal (RS) configuration associated with the TCI configuration, and a first value of control resource set (CORESET) pool indices, and performing a transmission or a reception with another cell according to applied configuration from the at least one of the TCI configuration, the RS configuration associated with the TCI configuration, and the first value of the CORESET pool indices. The RRC message includes first information of at least one of the TCI configuration, the RS configuration associated with the TCI configuration, and the first value of the CORESET pool indices, and the first information is associated with the another cell with a second physical cell identity (PCI) different from a first PCI of the serving cell.

According to one or more exemplary embodiments of the disclosure, a UE is provided. The UE includes, but is not limited to, a transceiver, on or more non-transitory computer-readable media having computer-executable instructions embodied thereon, and at least one processor coupled to the transceiver and the one or more non-transitory computer-readable media. The processor is configured to execute the computer-executable instructions to; receive, through the transceiver, a RRC message from a serving cell, apply at least one of TCI configuration, a RS configuration associated with the TCI configuration, and a first value of CORESET pool indices, and perform, through the transceiver, a transmission or a reception with another cell according to applied configuration from the at least one of the TCI configuration, the RS configuration associated with the TCI configuration, and the first value of the CORESET pool indices. The RRC message includes first information of at least one of the TCI configuration, the RS configuration associated with the TCI configuration, and the first value of the CORESET pool indices, and the first information is associated with the another cell with a second PCI different from a first PCI of the serving cell.

According to one or more exemplary embodiments of the disclosure, a network device is provided. The network device includes, but is not limited to, a transceiver, on or more non-transitory computer-readable media having computer-executable instructions embodied thereon, and at least one processor coupled to the transceiver and the one or more non-transitory computer-readable media. The processor is configured to execute the computer-executable instructions to; transmit, through the transceiver, a RRC message via a serving cell to a UE, and perform, through the transceiver, a transmission or a reception via another cell according to at least one of TCI configuration, RS configuration associated with the TCI configuration, and a first value of CORESET pool indices. The RRC message includes first information of at least one of the TCI configuration, the RS configuration associated with the TCI configuration, and the first value of the CORESET pool indices, and the first information is associated with the another cell with a second PCI different from a first PCI of the serving cell.

### BRIEF DESCRIPTION OF DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 is a schematic diagram that illustrates a radio communication network architecture according to an exemplary embodiment of the present disclosure.

FIG. 2 is a schematic diagram illustrating association in inter-cell beam management according to one of the exemplary embodiments of the disclosure.

FIG. 3 is a flow chart of a method adapted for a UE according to an exemplary embodiment of the present disclosure.

FIG. 4 is a flow chart of a method related to capability enquiry according to an exemplary embodiment of the present disclosure.

FIG. 5 is a schematic diagram illustrating the same MAC entity of the UE processes the message/information/signals transmitted to or received from the TRP of the serving cell (or the TRP associated with the PCI of the serving cell) and the TRP associated with a PCI different from the PCI of the serving cell according to one of the exemplary embodiments of the disclosure.

FIG. 6 is a schematic diagram illustrating different MAC entities of the UE processes the message/information/signals transmitted to or received from the TRP of the serving cell (or the TRP associated with the PCI of the serving cell) and the TRP associated with a PCI different from the PCI of the serving cell according to one of the exemplary embodiments of the disclosure.

FIG. 7 is a flow chart of a method adapted for a network device according to an exemplary embodiment of the present disclosure.

FIG. 8 is a block diagram illustrating a node for wireless communication according to one of the exemplary embodiments of the disclosure.

### DESCRIPTION OF EMBODIMENTS

The acronyms in the present disclosure are defined as follows and unless otherwise specified, the acronyms have the following meanings:

| Acronym | Full name |
|---|---|
| 3GPP | 3^{rd} Generation Partnership Project |
| 5GC | 5G Core |
| ACK | Acknowledgement |
| ARQ | Automatic Repeat Request |
| BS | Base Station |
| BWP | Bandwidth Part |
| CA | Carrier Aggregation |
| CCS | Common Search Space |
| CMAS | Commercial Mobile Alerting. System |
| CN | Core Network |
| CORESET | Control Resource Set |
| C-RNTI | Cell-Radio Network Temporary Identifier |
| DC | Dual Connectivity |
| DCI | Downlink Control Information |
| DL | Downlink |
| ETWS | Earthquake and Tsunami Warning System |
| HARQ | Hybrid Automatic Repeat Request |
| ICBM | Inter-Cell Beam Management |
| IE | Information Element |
| MAC | Medium Access Control |
| MCG | Master Cell Group |
| MIB | Master Information Block |
| MIMO | Multiple Input Multiple Output |
| MR | Multiple Radio Access Technologies |
| NG-RAN | Next-Generation Radio Access Network |
| NR | New Radio |
| NW | Network |
| PCell | Primary Cell |
| PCI | Physical Cell Identity |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PRACH | Physical Random Access Channel |
| PUCCH | Physical Uplink Control Channel |
| PUSCH | Physical Uplink Shared Channel |
| RA | Random Access |
| RACH | Random Access Channel |
| RAN | Radio Access Network |
| Rel | Release |
| RLC | Radio Link Control |
| RNTI | Radio Network Temporary Identifier |
| RRC | Radio Resource Control |
| RS | Reference Signal |
| SCell | Secondary Cell |
| SCG | Secondary Cell Group |
| SCS | Sub Carrier Spacing |
| SDAP | Service Data Adaptation Protocol |
| SDU | Service Data Unit |
| SFN | System Frame Number |
| SI | System Information |
| SIB | System Information Block |
| SRB | Signaling Radio Bearer |
| SSB | Synchronization Signal Blcok |
| TS | Technical Specification |
| TCI | Tranamission Configuration Indicator |
| TRP | Transmission and Reception Point |
| UCI | Uplink Control Information |
| UE | User Equipment |
| UL | Uplink |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”, which specifically indicates open-ended inclusion or membership in the so-described combination, group, series and the equivalent. The expression “at least one of A, B and C” or “at least one of the following: A, B and C” means “only A, or only B, or only C, or any combination of A, B and C”.

Any sentence, paragraph, (sub)-bullet, point, action, behavior, term, alternative, aspect, example, or claim described in the present disclosure may be combined logically, reasonably, and properly to form a specific method. Any sentence, paragraph, (sub)-bullet, point, action, behavior, term, alternative, aspect, example, or claim described in the present disclosure may be implemented independently and separately to form a specific method. Dependency, e.g., “based on”, “more specifically”, “in some implementations”, “in one alternative”, “in one example”, “in one aspect”, or etc., in the present disclosure is just one possible example in which would not restrict the specific method. One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc. According to any sentence, paragraph, (sub)-bullet, point, action, behavior, term, alternative, aspect, example, implementation, or claim described in the present disclosure, “X/Y” may include the meaning of “X or Y”. According to any sentence, paragraph, (sub)-bullet, point, action, behavior, term, alternative, aspect, example, implementation, or claim described in the present disclosure, “X/Y” may also include the meaning of “X and Y”. According to any sentence, paragraph, (sub)-bullet, point, action, behavior, term, alternative, aspect, example, implementation, or claim described in the present disclosure, “X/Y” may also include the meaning of “X and/or Y”.

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

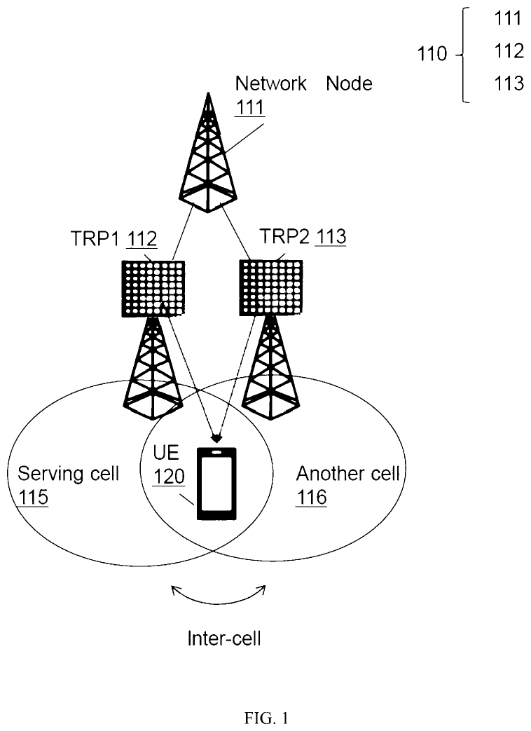

FIG. 1 is a schematic diagram that illustrates a radio communication network architecture according to an exemplary embodiment of the present disclosure. Referring to FIG. 1, a radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station 110, at least one UE 120, and one or more optional network elements that provide connection towards a network. The UE 120 communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations.

It should be noted that, in the present disclosure, a UE 120 may include, but is not limited to, a mobile station, a mobile terminal or device, a user communication radio terminal. For example, a UE 120 may be a portable radio equipment, which includes, but is not limited to, a mobile phone, a tablet, a wearable device, a sensor, a vehicle, or a Personal Digital Assistant (PDA) with wireless communication capability. The UE 120 is configured to receive and transmit signals over an air interface to one or more cells in a radio access network.

A base station 110 may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present disclosure should not be limited to the above-mentioned protocols.

A base station 110 may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS 110 may connect to serve the one or more UEs 120 through a radio interface to the network.

The base station 110 (or called network device) may be operable to provide radio coverage to a specific geographical area using a plurality of cells included in the RAN. The BS 110 may support the operations of the cells. Each cell may be operable to provide services to at least one UE within its radio coverage. Specifically, each cell (often referred to as a serving cell) may provide services to serve one or more UEs 120 within its radio coverage (e.g., each cell schedules the Downlink (DL) and optionally Uplink (UL) resources to at least one UE 120 within its radio coverage for DL and optionally UL packet transmission). The BS 110 may communicate with one or more UEs 120 in the radio communication system through the plurality of cells.

The base station 110 may include a network node 111 and one or more TRPs 112 and 113.

A network node 111 may be, but not limited to, a node B (NB) as in the LTE, an evolved node B (eNB) as in the LTE-A, a radio network controller (RNC) as in the UMTS, a base station controller (BSC) as in the GSM/GERAN, a new radio evolved node B (NR eNB) as in the NR, a next generation node B (gNB) as in the NR, and any other apparatus capable of controlling radio communication and managing radio resources within one or more cells.

A TRP (e.g., HF-TRP or LF-TRP) 112 or 113, which may also be regarded as a remote radio head (RRH), may be a transceiver under the protocols of 5G NR wireless communication system and/or the protocols of a 4G wireless communication system. A TRP 112 or 113 may be communicatively connected to a network node 111. The network node 111 may connect to serve the one or more UEs 120 through one or more TRPs 112 and 113 in the radio communication system.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

In addition, the terms “system”, “network”, and “network device” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the MAC entity is associated with the MCG or the SCG. Otherwise, the term Special Cell may refer to the PCell. A Special Cell may support a Physical Uplink Control Channel (PUCCH) transmission and contention-based Random Access (CBRA), and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

In the disclosure, the network (NW), network device, network node, cell, camped cell, serving cell, base station, gNB, eNB and ng-eNB may be used interchangeably. In some implementations, some of these items may refer to the same network entity.

The RAT may be (but not limited to) NR, LTE, E-UTRA connected to 5GC, LTE connected to 5GC, E-UTRA connected to EPC, and LTE connected to EPC. The proposed mechanism may be applied for UEs in public networks, or in private network (e.g., NPN (non-public network, SNPN (standalone NPN), PNI-NPN (public network integrated NPN)).

The proposed mechanism may be used for licensed frequency and/or unlicensed frequency.

System information (SI) may refer to MIB, SIB1, and other SI. Minimum SI may include MIB and SIB1. Other SI may refer to SIB3, SIB4, SIB5, and other SIB(s).

Dedicated signaling may refer to (but not limited to) RRC message(s). For example, RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration Complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message.

The RRC_CONNECTED UE, RRC_INACTIVE UE, and RRC_IDLE UE may apply the proposed implementations.

An RRC_CONNECTED UE may be configured with an active BWP with common search space configured to monitor system information or paging.

The RRC_CONNECTED UE configured with ICBM may be configured with an active BWP on the serving cell with common search space configured to monitor system information or paging from the serving cell.

The RRC_CONNECTED UE configured with ICBM may be configured with an active BWP on the target cell with common search space configured to monitor system information or paging from the target cell.

The UE may be served by a cell, e.g., serving cell. The serving cell may serve (but not limited to) an RRC_CONNECTED UE. The serving cell may be (but not limited to) a suitable cell.

The UE may camp on a cell, e.g., camped cell. The camped cell may be a suitable cell or an acceptable cell.

A suitable cell is a cell on which a UE may camp. The UE may consider a cell as suitable if the following conditions are fulfilled: (1) The cell is part of either the selected PLMN or the registered PLMN or PLMN of the Equivalent PLMN list, and (2) The cell criteria of the cell are fulfilled. Furthermore, according to the latest information provided by NAS, the suitable cell is not barred. The suitable cell is part of at least one TA that is not part of the list of “Forbidden Tracking Areas”, which belongs to a PLMN that fulfills the condition (1).

The target cell may be a suitable cell.

An acceptable cell is a cell on which the UE may camp to obtain limited service (originate emergency calls and receive ETWS and CMAS notifications). Such a cell may fulfil the following requirements, which is the minimum set of requirements to initiate an emergency call and to receive ETWS and CMAS notification in an NR network: (1) the cell is not barred, and/or (2) the cell selection criteria are fulfilled.

A DL BWP may refer to an initial (DL) BWP, a default BWP, an active (DL) BWP.

PCell (Primary Cell): The MCG cell, operating on the primary frequency, in which the UE either performs the initial connection establishment procedure or initiates the connection re-establishment procedure.

PSCell (Primary SCG Cell): For dual connectivity operation, the SCG cell in which the UE performs random access when performing the Reconfiguration with Sync procedure.

Serving Cell: For a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells.

Secondary Cell: For a UE configured with CA, a cell providing additional radio resources on top of Special Cell.

Special Cell: For Dual Connectivity operation the term Special Cell refers to the PCell of the MCG or the PSCell of the SCG, otherwise the term Special Cell refers to the PCell.

Master Cell Group: in MR-DC, a group of serving cells associated with the Master Node, comprising of the SpCell (PCell) and optionally one or more SCells.

Master node: in MR-DC, the radio access node that provides the control plane connection to the core network. It may be a Master eNB (in EN-DC), a Master ng-eNB (in NGEN-DC) or a Master gNB (in NR-DC and NE-DC).

Secondary Cell Group: in MR-DC, a group of serving cells associated with the Secondary Node, comprising of the SpCell (PSCell) and optionally one or more SCells.

Secondary node: in MR-DC, the radio access node, with no control plane connection to the core network, providing additional resources to the UE. It may be an en-gNB (in EN-DC), a Secondary ng-eNB (in NE-DC) or a Secondary gNB (in NR-DC and NGEN-DC).

The CSS may be a Type0-PDCCH CSS and/or a Type0A-PDCCH CSS.

The UE's required SI may be interpreted as the UE's required on-demand SI.

The on-demand SI may refer to the system information (e.g., Other SI) that the UE requests from the network. On demand SI may include SI message(s), SIB(s), and/or SIB segment(s).

In the disclosure, the terms “serving cell”, “TRP associated with the PCI of the serving cell”, and “TRP associated with the serving cell” may be used interchangeably.

In the disclosure, the terms “target cell”, “another cell”, “TRP associated with a PCI different from the PCI of the serving cell”, “TRP associated with a PCI of the target cell different from the PCI of the serving cell”, “TRP associated with a PCI of another cell different from the PCI of the serving cell”, “TRP associated with another cell”. and “TRP associated with the target cell” may be used interchangeably.

The serving cell in the implementations may be a PCell, SCell or PSCell.

The target cell in the implementations may be a PCell, SCell or PSCell.

An inter-cell to the serving cell of the UE may be a neighboring cell, a cell other than the serving cell, an additional cell, another cell or a cell with a PCI different from the PCI of the serving cell. Taking FIG. 1 as an example, TRP1 112 serves UE 120 within the coverage of a serving cell 115, and TRP2 113 serves UE 120 within the coverage of another cell 116. The another cell 116 is the inter-cell to the serving cell 115 of UE 120. If the UE can perform the inter-cell beam management, the UE may be in coverage of the inter-cell. TRP1 112 is associated with serving cell 115, and TRP2 113 is associated with another cell 116. TRP1 112 is associated with the PCI of serving cell 115, and TRP2 113 is associated with the PCI of another cell 116.

It is noted that in some implementations, if the UE is configured with inter-cell beam management, the UE is not required to acquire the SI from the serving cell while the UE is receiving (or can receive) DL-SCH from a TRP associated with a PCI different from the PCI of the serving cell. As presented in the implementations in the disclosure, it is possible that the UE may acquire the SI of the serving cell from the TRP associated with a PCI different from the PCI of the serving cell.

It is noted that in some implementations, when the UE is not receiving (or does not receive) DL-SCH from a TRP associated with a PCI different from the PCI of the serving cell, the UE may request the required system information of the target cell by transmitting an RRC message.

The term “MAC layer” and the term “MAC entity” may be used interchangeably.

It is noted that the system information may be associated with the serving cell and/or the system information may be associated with the target cell.

It is noted that when the UE is performing inter-cell beam management, it is fundamental but important for the UE to receive the system information, either associated to the serving cell or associated to the inter-cell of the serving cell. However, how to realize the system information transmission and reception when the UE is configured with inter-cell beam management and/or when the UE is in mTRP operation is not clear. In this disclosure, a mechanism to realize the system information transmission and reception is proposed, especially when the UE is configured with inter-cell beam management and/or when the UE is in mTRP operation, but not limited to. The mechanism comprises the approach the UE is configured to receive and transmit in mTRP operation and/or the approach the UE is configured to transmit and receive when the UE operates in the inter-cell beam management. The energy-efficient mechanism achieves signaling overhead reduction. The mechanism lays the foundation of inter-cell beam management and inter-cell mobility.

There may be serval scenarios.

### Mtrp Operation:

In one implementation, if multiple TRP (mTRP) operation is applied, a serving cell (or a network nde 111) can schedule a UE from two TRPs (e.g., TRPs 112 and 113 in FIG. 1). Multiple TRP operation is proposed and designed to provide more extensive coverage, enhance the reliability, and improve the data rate for downlink channels (e.g., PDSCH, PDCCH), downlink reference signal (e.g., Channel State Information-Reference Signal (CSI-RS), DeModulation Reference Signal (DMRS), SSB, Phase Tracking Reference Signal (PT-RS), Tracking Reference Signal (TRS)), uplink channels (e.g., Physical Uplink Shared Channel (PUSCH), Physical Uplink Control Channel (PUCCH)) and uplink reference signal (e.g., SRS) transmission/reception.

In one implementation, if mTRP PUCCH repetition is applied, a UE in TRP operation may perform PUCCH transmission of the same contents (or Transport Block (TB)) towards two TRPs with corresponding beam directions associated with different spatial relation information. Note that spatial relation information may contain parameters for configuring a spatial relation between reference signals (e.g., SRS, CSI-RS, or SSB) and a target reference signal set. For example, a target reference signal set may be the DM-RS ports of PUSCH or PUCCH. In addition, spatial relation information may further contain parameters for configuring power control for PUCCH or PUSCH.

In a single-cell case, the two TRPs may be associated with a PCI (Physical Cell Identity (ID)) of the serving cell.

In an inter-cell case, the two TRPs may be associated with different PCIs. Taking FIG. 1 as an example, one TRP1 112 may be associated with the PCI of the serving cell 115, while another TRP2 113 may be associated with a PCI of another cell 116 different from the PCI of the serving cell 115.

In one implementation, if mTRP PUSCH repetition is applied, according to the indications in a single DCI received by the UE from the serving cell (or from the TRP associated with the serving cell) and/or the indications in a semi-static configured grant provided over an RRC message received by the UE from the serving cell (or from the TRP associated with the serving cell), the UE may perform a set of PUSCH transmissions with the same contents (or transport blocks) towards two TRPs with corresponding beam directions associated with different spatial relation information in the time domain.

In a single-cell case, the two TRPs may be associated with a PCI of the serving cell. In an inter-cell case, the two TRPs may be associated with different PCIs. For example, one TRP may be associated with the PCI of the serving cell, while another TRP may be associated with a PCI different from the PCI of the serving cell.

In one implementation, for the inter-cell case, it is possible that the UE may receive the indications in a single DCI from the serving cell (or from the TRP associated with the serving cell) or from the TRP associated with a PCI different from the PCI of the serving cell. In one implementation, for the inter-cell case, it is possible that the UE may receive the indications in a semi-static configured grant over an RRC message from the serving cell (or from the TRP associated with the serving cell) or from the TRP associated with a PCI different from the PCI of the serving cell.

In one implementation, if mTRP PDCCH transmission is applied, a UE in mTRP operation may receive two PDCCH transmissions, one for each TRP, carrying the same DCI. There are two modes for mTRP PDCCH transmission: PDCCH repetition mode and Single Frequency Network (SFN) based PDCCH transmission mode. In PDCCH repetition mode, the UE may receive the two PDCCH transmissions carrying the same DCI format from two linked search space sets within a slot, wherein each search space set is associated with corresponding CORESETs. In SFN based PDCCH transmission mode, the UE may receive a PDCCH transmission carrying DCI in a given search space set from a CORESET with two TCI states. In one implementation, in SFN based PDCCH transmission mode, the UE may receive the two PDCCH transmissions carrying the same DCI from a single search space/CORESET using different TCI states.

In one implementation, in a single-cell case, for PDCCH repetition mode or other transmission modes, the two linked search spaces and the associated different CORESET(s) (or CORESET pool(s) indicated by a value of CORESET pool indices) are associated to the serving cell. In one implementation, in an inter-cell case, for PDCCH repetition mode or other transmission modes, one of the two linked search spaces and the associated CORESET (or CORESET pool(s) indicated by a value of CORESET pool indices) may be associated with (or may belong to) the serving cell, while the other one of the two linked search spaces and the associated CORESET (or CORESET pool(s) indicated by a value of CORESET pool indices) may be associated with (or may belong to) a TRP associated with a PCI different from the PCI of the serving cell. It is noted that a value of CORESET pool indices may be the value of parameter CORESETPoolIndex.

In one implementation, in a single-cell case, for SFN based PDCCH transmission mode, the single search space (or the single CORESET or the CORESET pool or the CORESETPoolIndex) and the corresponding TCI states may be associated with (or may belong to) the serving cell. In one implementation, in an inter-cell case, for SFN based PDCCH transmission mode, the single search space (or the single CORESET or the CORESET pool or the CORESETPoolIndex) and the corresponding TCI states may be associated with (or may belong to) a TRP associated with a PCI different from the PCI of the serving cell. For example, in case that there are two corresponding TCI states, one of the corresponding TCI states may be associated with (or may belong to) a TRP associated with a PCI different from the PCI of the serving cell, while the other one of the corresponding TCI states may be associated with (or may belong to) the serving cell. In general, some of the corresponding TCI states may be associated with (or may belong to) a TRP associated with a PCI different from the PCI of the serving cell, while some of the corresponding TCI states may be associated with (or may belong to) the serving cell. It is noted that the UE may receive the configuration of the corresponding TCI states from the serving cell or from the TRP associated with a PCI different from the PCI of the serving cell.

In one implementation, if mTRP PDSCH transmission is applied, a UE in mTRP operation may receive PDSCH transmission from two TRPs. If the two TRPs are associated to a serving cell of the UE, it is the case of single-cell mTRP PDSCH transmission. If the two TRPs are associated to different serving cells of the UE, it is the case of inter-cell mTRP PDSCH transmission.

Single-Cell mTRP PDSCH Transmission:

In one implementation, the control of UL and DL is done by PHY layer and MAC entity (of the UE and/or of the serving cell), within the configuration provide by the RRC layer (of the UE and/or of the serving cell). For example, the UE may receive the RRC message including the configuration for the single-cell mTRP PDSCH transmission from the serving cell and then the UE may configure itself with the configuration for the single-cell mTRP PDSCH transmission. The UE may further apply the configuration for the single-cell mTRP PDSCH transmission. Afterwards, the UE may receive MAC CE and/or DCI from the serving cell to activate/deactivate/apply the configuration for indicating TRP related information for the single-cell mTRP PDSCH transmission.

In one implementation, there are two different operation modes in the case of single-cell mTRP PDSCH transmission: single-DCI mode and multi-DCI mode. For single-DCI mode, the UE is scheduled by the same DCI for both TRPs, e.g., to receive mTRP PDSCH transmission from different TRPs The content of the PDSCH transmission from both TRPs scheduled by the same DCI is the same. For multi-DCI mode, the UE is scheduled by independent DCIs from different CORESET pools (e.g., indicated by different values of CORESET pool indices) for each corresponding TRP to receive mTRP PDSCH transmission. For example, one DCI is associated with one CORESET pool index corresponding to one value of CORESET pool indices, and another DCI is associated with another CORESET pool index corresponding to another value of CORESET pool indices. The content of the PDSCH transmission (e.g., the TB carried by PDSCH) from each TRP scheduled by each corresponding independent DCI may be different.

Inter-Cell mTRP PDSCH Transmission:

In one implementation, for inter-cell mTRP PDSCH transmission, multi-DCI PDSCH transmission may be applied. One or more TCI states can be associated with the SSB with a PCI different from the PCI of the serving cell. However, the activated TCI states can be associated with at most one PCI different from the PCI of a serving cell at a time. That is, among SSBs associated with corresponding PCIs different from the PCI of a serving cell, one or more TCI states may be configured to associate with these SSBs. However, those configured TCI states associated with SSBs, wherein the SSBs are associated with at most one PCI different from the PCI of a serving cell, may be activated at a time.

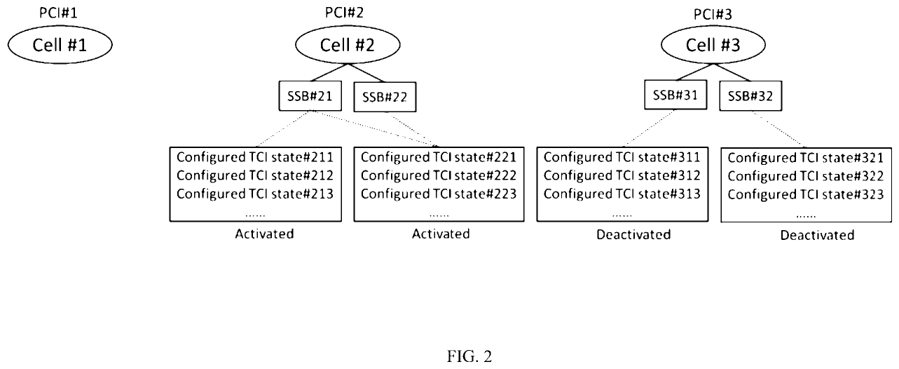

For example, FIG. 2 is a schematic diagram illustrating association in inter-cell beam management according to one of the exemplary embodiments of the disclosure. As shown in FIG. 2, Cell #1 is the serving cell of a UE, while Cell #2 and Cell #3 are inter-cells to the UE. Each cell has a corresponding PCI, e.g., the PCI of the serving cell, Cell #1, is PCI #1, the PCI of Cell #2 is PCI #2, and the PCI of Cell #3 is PCI #3. Each cell may have several SSBs. For example, Cell #2 has SSB #21 and SSB #22, but not limited to; while Cell #3 has SSB #31 and SSB #32, but not limited to. It is noted that the SSB box (e.g., SSB #21) illustrated in FIG. 2 may include one or more SSBs, i.e., a set of SSBs. Each SSB box (e.g., SSB #21) may be configured by the NW via RRC message to the UE with a set of TCI states. For instance, SSB #21 may be configured to associate with TCI state #211, TCI state #212, TCI state #213, TCI state #221, TCI state #222, TCI state #223, but not limited to. Similarly, the NW may transmit the RRC message including the TCI state configuration associated with a set of SSBs belonging to Cell #3, e.g., SSB #31 may be configured to associate with TCI state #311, TCI state #312, TCI state #313, but not limited to. However, though the UE receives the RRC message including the TCI configuration associated with SSBs belonging to inter-cells (or neighboring cells or cells other than the serving cell or additional cells or another cell), the NW (or the UE) may activate TCI states associated with at most one PCI different from the PCI of the serving cell at a time. For instance, as illustrated in FIG. 2, only the configured TCI states associated with SSBs belonging to Cell #2 with PCI #2 are activated, while the configured TCI states associated with SSBs belonging to Cell #3 with PCI #3 may not be activated.

Configuration in Inter-Cell mTRP Operation:

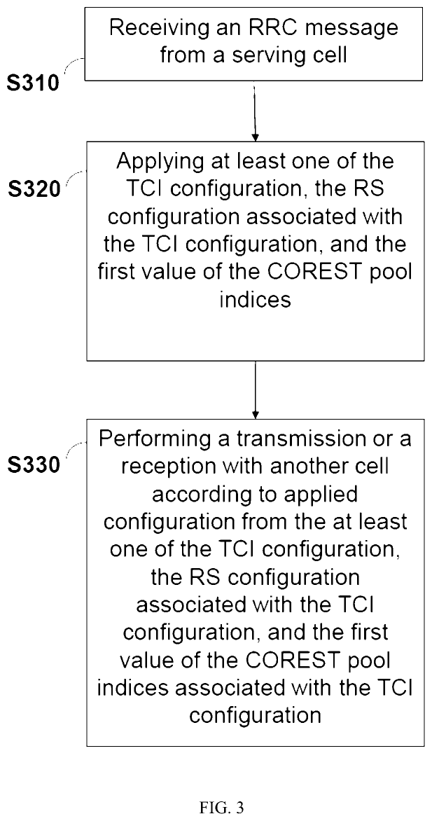

FIG. 3 is a flow chart of a method adapted for a UE according to an exemplary embodiment of the present disclosure. Referring to FIG. 3, note that the order of the steps in this Figure may be changed according to the actual requirements.

Step S310: a UE receives a radio resource control (RRC) message from a serving cell. The RRC message comprises first information of at least one of a transmission configuration indicator (TCI) configuration, a reference signal (RS) configuration associated with the TCI configuration, and a first value of control resource set (CORESET) pool indices, and the first information is associated with another cell with a second physical cell identity (PCI) different from a first PCI of the serving cell.

Step S320: the UE applies at least one of the TCI configuration, the RS configuration associated with the TCI configuration, and the first value of the CORESET pool indices.

Step S330: the UE performs a transmission or a reception with the another cell according to the applied configuration from the at least one of the TCI configuration, the RS configuration associated with the TCI configuration, and the first value of the CORESET pool indices.

In one implementation, in addition to SSBs, other reference signals such as CSI-RS, DMRS, Tracking Reference Signal (TRS) and Phase Tracking Reference Signal (PT-RS) may be applied and configured for inter-cell beam management including inter-cell mTRP PDSCH transmission, inter-cell mTRP PDCCH transmission, inter-cell mTRP PUCCH transmission and inter-cell mTRP PUSCH transmission.

For example, a UE may receive an RRC message from the serving cell. The RRC message may include the information of TCI configuration, the information of spatial relations configuration, the information of reference signal configuration associated with the TCI configuration and/or the information of reference signal configuration associated with the spatial relations configuration. The information of TCI configuration, the information of spatial relations configuration, the information of RS configuration associated with the TCI configuration, and/or the information of RS configuration associated with the spatial relations configuration may be associated with the serving cell. However, it is possible that the information of TCI configuration, the information of spatial relations configuration, the information of RS configuration associated with the TCI configuration, and/or the information of RS configuration associated with the spatial relations configuration may be associated with a TRP associated with the second PCI of another cell different from the first PCI of the serving cell.

In one implementation, the RRC message may further include second information of at least one of a second TCI configuration, a second RS configuration associated with the second TCI configuration, and a second value of the CORESET pool indices, and the second information is associated with the serving cell.

In one implementation, the first value of the CORESET pool indices in the first information is different from the second value of the CORESET pool indices in the second information. The CORESET pool(s) may be identified by the value of CORESET pool indices. The CORESET pool(s) may include at least one CORESET.

In one implementation, the first value of the CORESET pool indices is associated with the TCI configuration. In one implementation, the second value of the CORESET pool indices is associated with the TCI configuration. For example, the first value of the CORESET pool indices is associated with the first TCI configuration for the inter-cell (or additional cell or neighboring cell or another cell) other than the serving cell, while the second value of the CORESET pool indices is associated with the second TCI configuration for the serving cell.

In one implementation, the TCI configuration may be downlink TCI configuration (e.g., a list of TCI states configured for downlink reception), uplink TCI configuration (e.g., a list of TCI states configured for uplink transmission), and/or joint TCI configuration (e.g., a list of TCI states configured for both downlink reception and uplink transmission). In one implementation, the downlink reception may include reception of signal on DL channel (e.g., PDSCH or PDCCH) and/or reception of DL reference signal (e.g., DMRS, SSB). In one implementation, the uplink transmission may include transmission of signal on UL channel (e.g., PUSCH or PUCCH) and/or transmission of UL reference signal (e.g., SRS).

In one implementation, the information of reference signal configured with the TCI configuration may be the information of reference signal configured with the downlink TCI configuration, uplink TCI configuration, and/or joint TCI configuration.

In one implementation, a UE may add the TCI configuration in response to receiving the information of the TCI configuration including the TCI configuration to be added. In one implementation, a UE may modify the TCI configuration in response to receiving the information of the TCI configuration including the TCI configuration to be modified. That is, if the information of TCI configuration includes the TCI configuration to be added and/or modified, the UE may add and/or modified the indicated TCI configuration to the stored TCI configuration. In one implementation, a UE may store the TCI configuration in response to adding and/or modifying the TCI configuration. After the addition and/or modification, the UE may store the updated TCI configuration. In one implementation, a UE may release the TCI configuration in response to receiving the information of the TCI configuration including the TCI configuration to be released. That is, if the information of TCI configuration includes the TCI configuration to be released, the UE may release the indicated TCI configuration from the stored TCI configuration. In one implementation, a UE may store the remaining (or updated) TCI configuration in response to releasing the TCI configuration. After the release, the UE may store the updated TCI configuration.

In one example, the UE has stored the TCI configurations according to the previous RRC message carrying the information of the TCI configuration (e.g., the TCI state(s) to be released, the TCI state(s) to be modified, and the TCI state(s) to be added). If the UE receives a new RRC message carrying the information of TCI configuration, the UE may release one or more stored TCI state(s) according to the TCI state(s) indicated to be released by the new RRC message, modify one or more stored TCI state(s) according to the TCI state(s) indicated to be modified by the new RRC message, and add one or more TCI state(s) according to the TCI state(s) indicated to be added by the new RRC message.

In one implementation, if the information of spatial relations configuration includes the spatial relations configuration to be added and/or modified, the UE may add and/or modify the indicated spatial relations configuration to the stored spatial relations configuration. After the addition and/or modification, the UE may store the updated spatial relations configuration. If the information of spatial relations configuration includes the spatial relations configuration to be released, the UE may release the indicated spatial relations configuration from the stored spatial relations configuration. After the release, the UE may store the updated spatial relations configuration.

In one example, the UE has stored the spatial relations information according to the previous RRC message carrying the information of the spatial relations settings (e.g., the spatial relations setting(s) to be released, the spatial relations setting(s) to be modified, and the spatial relations setting(s) to be added). If the UE receives a new RRC message carrying the information of spatial relations settings, the UE may release one or more stored spatial relations information according to the spatial relations setting(s) indicated to be released by the new RRC message, modify one or more stored spatial relations information according to the spatial relations setting(s) indicated to be modified by the new RRC message, and add one or more spatial relations information according to the spatial relations setting(s) indicated to be added by the new RRC message.

In one implementation, if the information of RS configuration (e.g., the information of RS configuration associated with spatial relations configuration, the information of RS configuration associated with the TCI configuration) includes the RS configuration to be added and/or modified, the UE may add and/or modify the indicated RS configuration to the stored RS configuration. After the addition and/or modification, the UE may store the updated RS configuration. If the information of RS configuration includes the RS configuration to be released, the UE may release the indicated RS configuration from the stored RS configuration. After the release, the UE may store the updated RS configuration.

In one implementation, it is possible that the UE may maintain (e.g., update, add, modify, and release) the RS configuration associated with the spatial relations configuration and the RS configuration associated with the TCI configuration, respectively.

In one implementation, the UE may apply the updated TCI configuration and/or the associated updated RS configuration after the addition, modification and/or release. However, in one implementation, it is possible that the UE may only store but not yet apply the updated TCI configuration and/or the associated updated RS configuration after the addition, modification and/or release. In such case, upon the UE receives a DCI and/or a MAC CE to activate the updated TCI configuration and/or the associated updated RS configuration, the UE may start to apply the (stored) updated TCI configuration and/or the associated (stored) updated RS configuration. Upon the UE receives a DCI and/or a MAC CE to deactivate the activated TCI configuration and/or the associated activated RS configuration, the UE may deactivate the TCI configuration and/or the associated RS configuration, wherein the TCI configuration and/or the associated RS configuration may be indicated in the DCI and/or MAC CE.

In one example, the TCI configuration and/or the associated RS configuration may be updated by the RRC message, e.g., the UE may add, modify, and/or release the stored TCI state(s) at the UE side after the UE receives the RRC message. And the updated TCI configuration and/or the associated RS configuration (i.e., the TCI configuration and/or the associated RS configuration updated by the RRC message) may be activated/deactivated by the DCI and/or MAC CE. For example, the MAC CE may activate one or more TCI states included in the updated TCI configuration and then the UE may apply the activated TCI state(s) for downlink channel(s) reception and/or uplink channel(s) transmission. For another example, the MAC CE may activate one or more TCI states included in the updated TCI configuration(s) and a DCI may indicate which activated TCI states included in the MAC CE to be applied for downlink channel(s) reception and/or uplink channel(s) transmission. If (only) one TCI state is activated by the MAC CE, e.g., in a single-TRP case, then the UE may directly apply that TCI state for downlink channel(s) reception and uplink channel(s) transmission without the TCI state indication in the DCI. If (only) two TCI states are activated by the MAC CE, e.g., in mTRP case or in SFN case, then the UE may directly apply these two TCI states for downlink channel(s) reception and uplink channel(s) transmission without the TCI state indication in the DCI.

In one implementation, the UE may apply the updated spatial relations configuration and/or the associated updated RS configuration after the addition, modification and/or release. However, in one implementation, it is possible that the UE may (only) store but not yet apply the updated spatial relations configuration and/or the associated updated RS configuration after the addition, modification and/or release. In such case, upon the UE receives a DCI and/or a MAC CE to activate the updated spatial relations configuration and/or the associated updated RS configuration, the UE may start to apply the activated updated spatial relations configuration and/or the associated updated RS configuration. Upon the UE receives a DCI and/or a MAC CE to deactivate the activated spatial relations configuration and/or the associated activated RS configuration, the UE may deactivate the spatial relations configuration and/or the associated RS configuration, wherein the spatial relations configuration and/or the associated RS configuration may be indicated in the DCI and/or MAC CE.

In one implementation, the reference signal configuration may include the configuration of at least one of a set of SSB(s), a set of CSI-RS(s), a set of DMRS(s), a set of TRS(s) and a set of PT-RS(s). In one implementation, the reference signal configuration may include a list of SSB(s), a list of CSI-RS(s), a list of DMRS(s), a list of TRS(s) and a list of PT-RS(s) to be added and/or modified. In one implementation, the reference signal configuration may include a list of SSB(s), a list of CSI-RS(s), a list of DMRS(s), a list of TRS(s) and a list of PT-RS(s) to be released. The SSB(s) may be identified by SSB indices. The CSI-RS(s) may be identified by CSI-RS indices. The DMRS(s) may be identified by DMRS indices. The TRS(s) may be identified by TRS indices. The PT-RS(s) may be identified by PT-RS indices.

In one implementation, the TCI configuration may include a list of TCI states to be added and/or modified, and a list of TCI states to be released. The TCI states may be identified by TCI state indices. It is noted that a list of TCI states may be a list of DL TCI states, UL TCI states, joint TCI states, and/or a list of TCI states for indicating joint TCI states of different TRPs.

In one implementation, the spatial relations configuration may include a list of spatial relations to be added and/or modified, and a list of spatial relations to be released. The spatial relations may be identified by the indices of spatial relations, and/or identified by an indicated joint TCI state or UL TCI state.

In one implementation, the UE may receive the RRC message when the UE is in RRC_CONNECTED state. However, in one implementation, it is possible that the UE may receive the RRC message when the UE is in RRC_INACTIVE state.

In one implementation, the UE may receive the RRC message from the serving cell. However, in one implementation, it is possible that the UE may receive the RRC message from a TRP associated with a PCI of another cell different from the PCI of the serving cell.

In one implementation, once the UE applies the TCI configuration, the RS configuration associated with the TCI configuration, the spatial relations configuration, a value of the CORESET pool indices, and/or the RS configuration associated with the spatial relations configuration, where the TCI configuration, the RS configuration associated with the TCI configuration, the spatial relations configuration, the value of the CORESET pool indices, and/or the RS configuration associated with the spatial relations configuration are associated with a TRP associated with a PCI of another cell different from the PCI of the serving cell, the UE may perform an inter-cell PDSCH reception to receive PDSCH transmission from the TRP associated with a PCI of another cell different from the PCI of the serving cell, perform an inter-cell PDCCH reception to receive PDCCH transmission from the TRP associated with a PCI different of another cell from the PCI of the serving cell, perform an inter-cell downlink reference signal reception from a TRP associated with a PCI of another cell different from the PCI of the serving cell, perform an inter-cell PUSCH transmission to transmit PUSCH to a TRP associated with a PCI of another cell different from the PCI of the serving cell, perform an inter-cell PUCCH transmission to transmit PUCCH to a TRP associated with a PCI of another cell different from the PCI of the serving cell, and/or perform an inter-cell uplink reference signal transmission to a TRP associated with a PCI of another cell different from the PCI of the serving cell. Note that the TCI configuration may be downlink TCI configuration (e.g., a list of TCI states configured for downlink channels), uplink TCI configuration (e.g., a list of TCI states configured for uplink channels), and/or joint TCI configuration (e.g., a list of TCI states configured for both downlink channels and uplink channels). Similarly, the information of reference signal configurated with the TCI configuration may be the information of reference signal configured with the downlink TCI configuration, uplink TCI configuration, and/or joint TCI configuration. The downlink reference signal may include DeModulation Reference Signal (DMRS), Channel State Information Reference Signal (CSI-RS), SSB, TRS, and PT-RS. The uplink reference signal may include Sounding Reference Signal (SRS).

In one implementation, if the UE is enabled to perform the inter-cell PDSCH reception, the inter-cell PDCCH reception, the inter-cell downlink reference signal reception, the inter-cell PUSCH transmission, the inter-cell uplink reference signal transmission, and/or the inter-cell PUCCH transmission, the UE may be considered to be configured with inter-cell beam management (ICBM), and/or the UE may perform inter-cell beam management.

In one example, the ICBM configuration (e.g., RS(s) for beam failure detection, beam indication) associated with a TRP associated with the PCI of the serving cell and associated with TRP(s) with PCI(s) different from the PCI of the serving cell may be configured by the RRC messages. Once the UE is enabled to perform inter-cell PDSCH reception, the inter-cell PDCCH reception, the downlink reference signal reception, the uplink reference signal transmission, the inter-cell PUSCH transmission, and/or the inter-cell PUCCH transmission, the UE may apply ICBM according to the ICBM configuration configured by the RRC message (or received in the RRC message).

In one example, once the UE is configured to perform one of the inter-cell PDSCH reception, the inter-cell PDCCH reception, the downlink reference signal reception, the uplink reference signal transmission, the inter-cell PUSCH transmission, and the inter-cell PUCCH transmission, the UE is expected to apply ICBM for DL reference signals, DL channels, UL reference signals, and UL channels.

In one example, the UE may perform ICBM for DL and single cell beam management for UL. Oppositely, the UE may perform ICBM for UL and single cell beam management for DL.

### Inter-Cell Beam Management:

In one implementation, the UE may be configured with inter-cell beam management by the NW, by pre-configuration, or by UE capability.

For example, after receiving the configuration including information related to inter-cell beam management, the UE may determine that it is configured with inter-cell beam management by the NW. The configuration including information related to inter-cell beam management may be included in an RRC message, a MAC CE and/or a DCI.

The configuration including information related to inter-cell beam management may be or may include (but not limited to) the information of TCI configuration associated with a TRP associated with a PCI of another cell different from the PCI of the serving cell, the information of spatial relations configuration associated with a TRP associated with a PCI of another cell different from the PCI of the serving cell, the information of RS configuration associated with the TCI configuration associated with a TRP associated with a PCI of another cell different from the PCI of the serving cell, the information of a value of CORESET pool indices associated with a TRP associated with a PCI of another cell different from the PCI of the serving cell, and/or the information of RS configuration associated with the spatial relations configuration associated with a TRP associated with a PCI of another cell different from the PCI of the serving cell. Note that the TCI configuration may be downlink TCI configuration (e.g., a list of TCI states configured for downlink channels), uplink TCI configuration (e.g., a list of TCI states configured for uplink channels), and/or joint TCI configuration (e.g., a list of TCI states configured for both downlink channels and uplink channels). Similarly, the information of reference signal configurated with the TCI configuration may be the information of reference signal configured with the downlink TCI configuration, uplink TCI configuration, and/or joint TCI configuration.

In one implementation, a UE may be (pre) configured with a capability of performing the transmission or the reception according to the applied configuration from the at least one of the TCI configuration, the RS configuration associated with the TCI configuration, and the first value of the CORESET pool indices. The pre-configuration may be stored in USIM, based on the UE device itself and/or based on the releases.

For example, the UE may be preconfigured with the capability to perform inter-cell beam management. The pre-configuration may be stored in USIM, based on the UE device itself and/or based on the releases. A UE with an advanced release (e.g., Rel-17 and beyond) may be preconfigured with inter-cell beam management. The UE may determine whether it is configured with inter-cell beam management based on the preconfigured information.

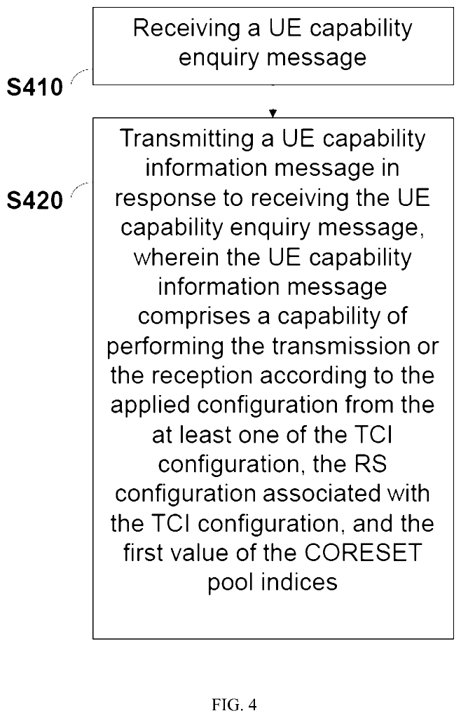

FIG. 4 is a flow chart of a method related to capability enquiry according to an exemplary embodiment of the present disclosure. Referring to FIG. 4, in one implementation, a UE may receive a UE capability enquiry message (step S410), and transmit a UE capability information message in response to receiving the UE capability enquiry message (step S420). The UE capability information message may include a capability of performing the transmission or the reception according to the applied configuration from the at least one of the TCI configuration, the RS configuration associated with the TCI configuration, and the first value of the CORESET pool indices.

For example, after the UE receives UE Capability Enquiry message from the serving cell, the UE may include the information related to the capability of performing the inter-cell beam management in UE Capability Information message. Afterwards, the UE (e.g., especially the RRC layer of the UE) may submit UE Capability Information message to lower layers (e.g., PDCP layer of the UE, RLC layer of the UE, MAC layer of the UE, PHY layer of the UE) for transmission to the serving cell.

After the reception of UE Capability Enquiry message, the UE may determine whether at least one of the information regarding the support of inter-cell beam management, the information regarding the support of feMIMO, the information regarding the support of a higher frequency band (e.g., FR2), and the information regarding the support of NR, exists in UE Capability Enquiry message.

In one implementation, if at least one of the information regarding the support of inter-cell beam management, the information regarding the support of feMIMO, the information regarding the support of a higher frequency band (e.g., FR2), and the information regarding the support of NR exists in UE Capability Enquiry message, the UE may further determine whether it supports inter-cell beam management and/or whether it is (pre) configured with inter-cell beam management.

In one implementation, if none of the information regarding the support of inter-cell beam management, the information regarding the support of feMIMO, the information regarding the support of a higher frequency band (e.g., FR2), and the information regarding the support of NR exists in UE Capability Enquiry message, the UE may not further determine whether it supports inter-cell beam management nor whether it is (pre) configured with inter-cell beam management.

In one implementation, after the UE determines that it supports inter-cell beam management and/or it is (pre) configured with inter-cell beam management, the UE may include the information related to the capability of performing the inter-cell beam management in UE Capability Information message.

In one implementation, after the UE determines that it does not support inter-cell beam management nor it is not (pre) configured with inter-cell beam management, the UE may not include the information related to the capability of performing the inter-cell beam management in UE Capability Information message.

In one example, the UE Capability Information message may include the supported number of cells for operating ICBM.

In one implementation, for inter-cell beam management (e.g., if the UE is configured with inter-cell beam management), the UE can receive or transmit UE dedicated channels/signals via a TRP associated with a PCI of another cell different from the PCI of the serving cell, while non-UE-dedicated channel/signals can only be received via a TRP associated with the PCI of the serving cell.

In some implementations, the UE dedicated channels/signals may include, but not limited to, the messages/signals/information via logical channels such as Dedicated Control Channel (DCCH) and Dedicated Traffic Channel (DTCH). In some implementations, the UE dedicated channels/signals may include, but not limited to, the signals/information via PDCCH and/or PUCCH.

DCCH: DCCH is a point-to-point bi-directional (including UL and DL) control channel that transmits dedicated control (plane) information between a UE and the network. DCCH may be used by a UE having RRC connection.

DCCH—DL-SCH (The logical channel DCCH can be mapped to the transport channel DL-SCH): The MAC entity of the UE may receive the DL control message/information/signals on the transport channel DL-SCH. After the processing in the MAC entity of the UE, the MAC entity of the UE may transfer the processed DL control message/information/signals via the logical channel DCCH to the upper layer (e.g., the PDCP layer of the UE, the RRC layer of the UE). For example, the RRC layer of the UE may receive the DL RRC message such as RRC Reconfiguration message, RRC Resume message, RRC Reestablishment message, RRC Release message, UE Capability Enquiry message, UE Information Request message, and Logged Measurement Configuration message, via the logical channel DCCH mapped to the transport channel DL-SCH, from the lower layers of the UE.

DCCH—UL-SCH (The logical channel DCCH can be mapped to the transport channel UL-SCH): The MAC entity of the UE may receive the UL control message/information/signals on the logical channel DCCH. After the processing in the MAC entity of the UE, the MAC entity of the UE may transfer the processed UL control message/information/signals via the transport channel UL-SCH to the lower layer (e.g., the PHY layer of the UE). For example, the RRC layer of the UE may transmit the UL RRC message such as RRC Reconfiguration Complete message, RRC Resume Complete message, RRC Reestablishment Complete message, RRC Setup Complete message, Measurement Report message, UE Capability Information message, UE Assistance Information message, and Dedicated SIB Request message, via the logical channel DCCH mapped to the transport channel UL-SCH, to the lower layers of the UE.

DTCH: DTCH is a point-to-point traffic channel, dedicated to one UE, for the transfer of user (plane) information. A DTCH can exist in both uplink and downlink.

DTCH—DL-SCH (The logical channel DTCH can be mapped to the transport channel DL-SCH): The MAC entity of the UE may receive the DL user information/signals on the transport channel DL-SCH. After the processing in the MAC entity of the UE, the MAC entity of the UE may transfer the processed DL user information/signals via the logical channel DTCH to the upper layer (e.g., the PDCP layer of the UE, the RRC layer of the UE).

DTCH—UL-SCH (The logical channel DTCH can be mapped to the transport channel UL-SCH): The MAC entity of the UE may receive the UL user information/signals on the logical channel DTCH. After the processing in the MAC entity of the UE, the MAC entity of the UE may transfer the processed UL user information/signals via the transport channel UL-SCH to the lower layer (e.g., the PHY layer of the UE).

In some implementations, the non-UE dedicated channels/signals may include, but not limited to, the messages/signals/information via logical channels such as Broadcast Control Channel (BCCH), Paging Control Channel (PCCH) and/or Common Control Channel (CCCH).

BCCH: BCCH is a downlink channel for broadcasting system control information.

BCCH—BCH (The logical channel BCCH can be mapped to the transport channel BCH): The MAC entity of the UE may receive the DL control message/information/signals on the transport channel BCH. After the processing in the MAC entity of the UE, the MAC entity of the UE may transfer the processed DL control message/information/signals via the logical channel BCCH to the upper layer (e.g., the PDCP layer of the UE, the RRC layer of the UE). For example, the RRC layer of the UE may receive the MIB message, via the logical channel BCCH mapped to the transport channel BCH, from the lower layers of the UE.

BCCH—DL-SCH (The logical channel BCCH can be mapped to the transport channel DL-SCH): The MAC entity of the UE may receive the DL control message/information/signals on the transport channel DL-SCH. After the processing in the MAC entity of the UE, the MAC entity of the UE may transfer the processed DL control message/information/signals via the logical channel BCCH to the upper layer (e.g., the PDCP layer of the UE, the RRC layer of the UE). For example, the RRC layer of the UE may receive the SIB1 message and System Information message, via the logical channel BCCH mapped to the transport channel DL-SCH, from the lower layers of the UE.

PCCH: PCCH is a downlink channel that carries paging messages.

PCCH—PCH (The logical channel PCCH can be mapped to the transport channel PCH): The MAC entity of the UE may receive the DL control message/information/signals on the transport channel PCH. After the processing in the MAC entity of the UE, the MAC entity of the UE may transfer the processed DL control message/information/signals via the logical channel PCCH to the upper layer (e.g., the PDCP layer of the UE, the RRC layer of the UE). For example, the RRC layer of the UE may receive the Paging message, via the logical channel PCCH mapped to the transport channel PCH, from the lower layers of the UE.

CCCH: CCCH is a channel for transmitting control information between UEs and network. This channel is used for UEs having no RRC connection with the network.

CCCH—DL-SCH (The logical channel CCCH can be mapped to the transport channel DL-SCH): The MAC entity of the UE may receive the DL control message/information/signals on the transport channel DL-SCH. After the processing in the MAC entity of the UE, the MAC entity of the UE may transfer the processed DL control message/information/signals via the logical channel CCCH to the upper layer (e.g., the PDCP layer of the UE, the RRC layer of the UE). For example, the RRC layer of the UE may receive the DL RRC message such as RRC Setup message and RRC Reject message, via the logical channel CCCH mapped to the transport channel DL-SCH, from the lower layers of the UE.

CCCH—UL-SCH (The logical channel CCCH can be mapped to the transport channel UL-SCH): The MAC entity of the UE may receive the UL control message/information/signals on the logical channel CCCH. After the processing in the MAC entity of the UE, the MAC entity of the UE may transfer the processed UL control message/information/signals via the transport channel UL-SCH to the lower layer (e.g., the PHY layer of the UE). For example, the RRC layer of the UE may transmit the UL RRC message such as RRC Resume Request message, RRC Reestablishment Request message, RRC Setup Request message and RRC System Information Request message, via the logical channel CCCH mapped to the transport channel UL-SCH, to the lower layers of the UE.

In one implementation, if the UE is configured with inter-cell beam management or when the UE is performing the inter-cell beam management operation, the UE may transmit the message/information/signals to or receive message/information/signals from a TRP associated with a PCI different from the PCI of the serving cell. The PCI that the TRP is associated with may belong to another cell, i.e., a cell with a TRP associated with a PCI different from the PCI of the serving cell. For the ease of illustration, we may name such another cell as “a target cell”.

Scenario 1: Intra-Node (e.g., in Carrier Aggregation (CA) Case):

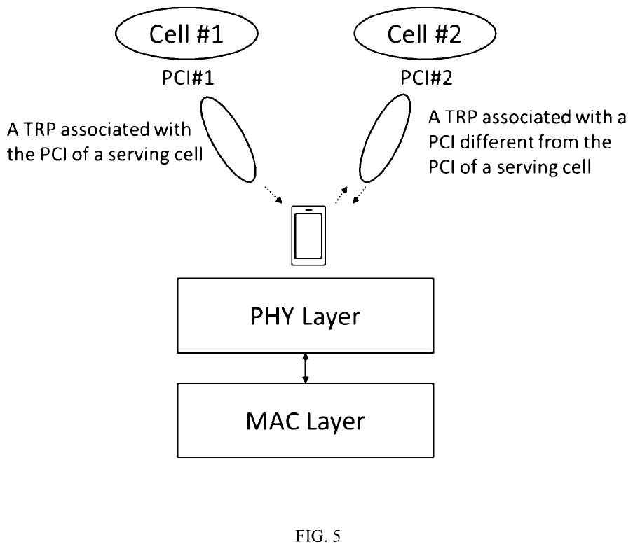

FIG. 5 is a schematic diagram illustrating the same MAC entity of the UE processes the message/information/signals transmitted to or received from the TRP of the serving cell (or the TRP associated with the PCI of the serving cell) and the TRP associated with a PCI different from the PCI of the serving cell according to one of the exemplary embodiments of the disclosure. Referring to FIG. 5, the UE may apply the same MAC entity of the UE to the serving cell and to the target cell. It is possible that the serving cell and the target cell may be operated by the same network node (e.g., master node), but not limited to. From the UE's perspectives, when the UE is configured with inter-cell beam management or when the UE is performing inter-cell beam management, the UE may receive non-UE dedicated channels/signals via a TRP associated with a PCI of the serving cell (e.g., Cell #1 in FIG. 5) and transmit/receive UE dedicated channels/signals via a TRP associated with a PCI different from the PCI of the serving cell, as illustrated in FIG. 5. In one implementation, it is possible to apply for the single TRP operation and inter-cell beam management. In one implementation, the UE may receive non-UE dedicated channels/signals via a TRP associated with a PCI of the serving cell (e.g., Cell #1 in FIG. 5) and transmit/receive UE dedicated channels/signals via a TRP associated with a PCI different from the PCI of the serving cell and/or a TRP associated with the PCI of the serving cell. It is possible to apply for the mTRP operation and inter-cell beam management.

In one implementation, it is possible that the serving cell and the target cell may operate on the same frequency band or different frequency bands. In one implementation, it is possible that the TRP of the serving cell and the TRP of the target cell may be spatial multiplexing. In one implementation, if the TRP of the serving cell and the TRP of the target cell operate on different component carriers, the UE may perform CA between the serving cell and the target cell, wherein the serving cell may be the primary cell and the target cell may be the secondary cell.

### Scenario 2: Inter-Node (e.g., in Dual-Connectivity (DC) Case):

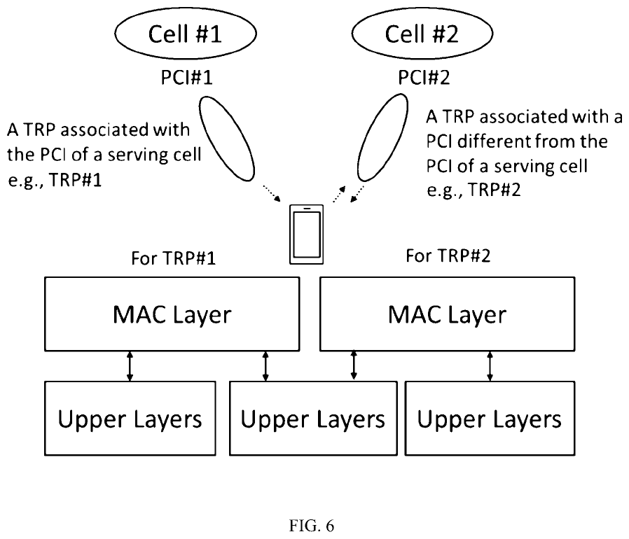

FIG. 6 is a schematic diagram illustrating different MAC entities of the UE processes the message/information/signals transmitted to or received from the TRP of the serving cell (or the TRP associated with the PCI of the serving cell) and the TRP associated with a PCI different from the PCI of the serving cell according to one of the exemplary embodiments of the disclosure. Referring to FIG. 6, in one implementation, the UE may apply one MAC entity of the UE to process the message/information/signals received from or transmitted to the serving cell and apply another MAC entity of the UE to process the message/information/signals received from or transmitted to the target cell, respectively. In one implementation, it is possible that the serving cell and the target cell may be operated by different network nodes (e.g., one by the master node and the other by the secondary node), but not limited to. From the UE's perspectives, when the UE is configured with inter-cell beam management or when the UE is performing inter-cell beam management, the UE may receive non-UE dedicated channels/signals via a TRP associated with a PCI of the serving cell (e.g., Cell #1 in FIG. 6) and transmit/receive UE dedicated channels/signals via a TRP associated with a PCI different from the PCI of the serving cell, as illustrated in FIG. 6. In one implementation, it is possible to apply for the single TRP operation and inter-cell beam management. In one implementation, the UE may receive non-UE dedicated channels/signals via a TRP associated with a PCI of the serving cell (e.g., Cell #1 in FIG. 6) and transmit/receive UE dedicated channels/signals via a TRP associated with a PCI different from the PCI of the serving cell and/or a TRP associated with the PCI of the serving cell. In one implementation, it is possible to apply for the mTRP operation and inter-cell beam management. For example, Cell #1 may associate with two TRPs while Cell #2 may associate with single TRP.

In one implementation, it is possible that the serving cell and the target cell may operate on the same frequency band or different frequency bands. In one implementation, it is possible that the TRP of the serving cell and the TRP of the target cell may be spatial multiplexing. In one implementation, if the TRP of the serving cell and the TRP of the target cell operate on different frequency carriers, the UE may perform Multi-Connectivity (MC) or Dual-Connectivity (DC) between the serving cell and the target cell, wherein the serving cell may be the primary cell and the target cell may be the primary secondary cell or the secondary cell.

### PDCCH CSS for System Information:

In one implementation, a set of PDCCH candidates for a UE to monitor is defined in terms of PDCCH search space sets. A search space set can be a CSS set or a UE-specific Search Space (USS) set. A UE may monitor PDCCH candidates in one or more of the following search spaces sets:

(1) a Type0-PDCCH CSS set configured by pdcch-ConfigSIB1 IE in MIB or by searchSpaceSIB1 IE in PDCCH-ConfigCommon IE or by searchSpaceZero in PDCCH-ConfigCommon IE, for a Downlink Control Indicator (DCI) format with Cyclic Redundancy Check (CRC) scrambled by a System Information Radio Network Temporary Identifier (SI-RNTI) on the primary cell of the Master Cell group (MCG). It is noted that SearchSpaceZero IE is used for Initial BWP only. It is assumed that the UE may (always) be configured with a Type-O-PDCCH CSS to receive SIB1.

In one implementation, for inter-cell beam management, the Type0-PDCCH CSS set may be configured to the UE per cell, per TRP, and/or per BWP. For example, a Type0-PDCCH CSS set for a DCI format with CRC scrambled by a SI-RNTI on the serving cell, a Type0-PDCCH CSS set for a DCI format with CRC scrambled by a SI-RNTI on the target cell.

(2) a Type0A-PDCCH CSS set configured by searchSpaceOtherSystemInformation IE in PDCCH-ConfigCommon IE, for a DCI format with CRC scrambled by a SI-RNTI on the primary cell of the MCG. It is noted that searchSpaceOtherSystemInformation IE indicates the ID of the search space for other system information, i.e., SIB2 and beyond. If the field is absent, the UE may not receive other system information in this BWP. In one implementation, the UE may be configured with common search space to receive other SI on the active DL BWP, via RRC message by the network. In one implementation, the UE may be configured with common search space to receive other SI on the initial DL BWP, via SIB1 and/or RRC message by the network.

In one implementation, for inter-cell beam management, the Type0A-PDCCH CSS set may be configured to the UE per cell, per TRP, and/or per BWP. For example, a Type0A-PDCCH CSS set for a DCI format with CRC scrambled by a SI-RNTI on the serving cell, a Type0A-PDCCH CSS set for a DCI format with CRC scrambled by a SI-RNTI on the target cell.

In one implementation, for a DL BWP, if the UE is not provided with searchSpaceOtherSystemInformation IE for Type0A-PDCCH CSS set, the UE may not monitor PDCCH for Type0A-PDCCH CSS set on the corresponding DL BWP. Thus, the UE may not receive the other SI on the DL BWP.

(3) A TypeX-PDCCH CSS set may be configured to a UE supporting ICBM per cell, per TRP, or/and per BWP. For example, the UE may receive other SI for multiple TRP scheme (e.g., intra-cell scenario, inter-cell scenario, intra-node scenario, or/and inter-node scenario) through monitoring DCI in the Type-X PDCCH CSS set.

### System Information Transmission and Reception:

The implementations for system information transmission and reception in this disclosure are generally applied to the case when the UE is configured with inter-cell beam management, but not limited to.

In one implementation, when the UE configured with inter-cell beam management is receiving DL-SCH from a TRP associated with a PCI different from the PCI of the serving cell, the UE may receive the Other SI via a UE dedicated logical channel (e.g., DCCH) on the transport channel DL-SCH.

Other SI encompasses all SIBs (e.g., SIB2, SIB3, SIB4, slice-specific SIB, sidelink-specific SIB, NPN-specific SIB) not broadcast in the Minimum SI (e.g., MIB, SIB1).

Other SI may be transmitted by the network in a dedicated manner on DL-SCH to UEs in RRC_CONNECTED.

### Section 1—System Information Reception:

In one implementation, without the UE's request in advance, the UE may receive the Other SI in a dedicated signaling via DCCH on DL-SCH from the TRP associated with a PCI different from the PCI of the serving cell. The Other SI may be included or encapsulated in the dedicated signaling. The dedicated signaling may be, but not limited to, RRC Reconfiguration message, RRC Reestablishment message, RRC Release message and UE Capability Enquiry message. We demonstrate the design by taking RRC reconfiguration procedure for example. However, the design may not be limited to apply RRC Reconfiguration message, RRC Reconfiguration Complete message and other RRC message mentioned in the example. Other RRC messages and RRC procedures (e.g., RRC reestablishment procedure, RRC release procedure, UE capability enquiry procedure) may be applied in the design.

An RRC procedure by taking RRC reconfiguration procedure for example:

The Network may initiate the RRC reconfiguration procedure to a UE in RRC_CONNECTED via the TRP associated with a PCI different from the PCI of the serving cell. The purpose of this RRC reconfiguration procedure is to provide the UE with system information (e.g., Other SI) when the UE is configured with inter-cell beam management and the UE is receiving DL-SCH from the TRP associated with a PCI different from the PCI of the serving cell.

The UE may receive the RRC reconfiguration message from the network via the TRP associated with a PCI different from the PCI of the serving cell.

In Scenario 1: If the UE applies the same MAC entity of the UE to process the message/information/signals received from or transmitted to the TRP associated with the PCI of the serving cell and the TRP associated with a PCI different from the PCI of the serving cell, the UE may receive the RRC Reconfiguration message including system information (e.g., MIB, SIB1, Other SI) and/or the indication for acquisition of MIB and/or SIB1 and/or the indication for acquisition of SIB1 and/or Other SI, from the TRP associated with a PCI different from the PCI of the serving cell.

The system information (e.g., MIB, SIB1, Other SI) received via the TRP associated with a PCI different from the PCI of the serving cell may be synchronized with or the same as the system information received from the TRP associated with the PCI of the serving cell. That is, the system information received via the TRP associated with a PCI different from the PCI of the serving cell may be associated with the serving cell.

The UE may not be required to acquire the system information from the serving cell while the UE is receiving RRC Reconfiguration including the SI via DL-SCH from the TRP associated with a PCI different from the PCI of the serving cell. The UE may receive the RRC Reconfiguration message via SRB1 or a new SRB. The new SRB may be a signaling radio bearer to carry the specific RRC message between the UE and a target cell via a TRP associated with the PCI different from the PCI of the serving cell, e.g., using logical channel DCCH, using transport channel DL-SCH for DL RRC messages and transport channel UL-SCH for UL RRC messages.

In one implementation, upon the UE receives the RRC Reconfiguration message including the system information via the TRP associated with a PCI different from the PCI of the serving cell (via SRB1 or a new SRB), the UE may perform the action upon reception of System Information as specified in Section 5.2.2.4 in 3GPP TS 38.331. The UE may not be required to acquire the system information from the serving cell. After the reception of the RRC Reconfiguration message or after (successfully) performing the action upon reception of SI, the UE may transmit the RRC Reconfiguration Complete message to the TRP associated with a PCI different from the PCI of the serving cell via SRB1 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB.

In one implementation, upon the UE receives the RRC Reconfiguration message via the TRP associated with a PCI different from the PCI of the serving cell, wherein the RRC Reconfiguration message includes the indication for acquisition of system information, the UE may acquire the SI message(s) as defined in sub-clause 5.2.2.3 in 3GPP TS 38.331, via the TRP associated with the PCI of the serving cell. The UE may still be required to acquire the system information from the serving cell. The implementation may be applied when the target cell does not have the same system information as the serving cell, e.g., especially when the target cell and the serving cell are not synchronized or are not operated by the same network node. After the reception of the RRC Reconfiguration message or after (successfully) performing the action upon reception of SI, the UE may transmit the RRC Reconfiguration Complete message to the TRP associated with a PCI different from the PCI of the serving cell via SRB1 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB. Alternatively, after the reception of the RRC Reconfiguration message or after (successfully) performing the action upon reception of SI, the UE may transmit the RRC Reconfiguration Complete message to the TRP associated with the PCI of the serving cell via SRB1.

It is noted that the indication of acquisition of system information may further include the information regarding the system information associated with the serving cell to be acquired and/or the system information associated with the target cell to be acquired.

In one implementation, upon the UE receives the RRC Reconfiguration message via the TRP associated with a PCI different from the PCI of the serving cell, wherein the RRC Reconfiguration message includes the indication for acquisition of MIB and/or SIB1, the UE may acquire the MIB and/or SIB1 as defined in sub-clause 5.2.2.3 in 3GPP TS 38.331, via the TRP associated with the PCI of the serving cell. The UE may still be required to acquire the MIB and/or SIB1 from the serving cell, while the UE may acquire Other SI from the target cell. After the reception of the RRC Reconfiguration message or after (successfully) performing the action of acquiring the MIB and/or SIB1, the UE may transmit the RRC Reconfiguration Complete message to the TRP associated with a PCI different from the PCI of the serving cell via SRB1 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB. Alternatively, after the reception of the RRC Reconfiguration message or after (successfully) performing the action of acquiring the MIB and/or SIB1, the UE may transmit the RRC Reconfiguration Complete message to the TRP associated with the PCI of the serving cell via SRB1.

In one implementation, upon the UE receives the RRC Reconfiguration message via the TRP associated with a PCI different from the PCI of the serving cell, wherein the RRC Reconfiguration message includes the indication for acquisition of system information, the UE may acquire the SI message(s) as defined in sub-clause 5.2.2.3 in 3GPP TS 38.331, via the TRP associated with a PCI different from the PCI of the serving cell. The UE may not be required to acquire system information from the serving cell. The BWP (e.g., the initial BWP, the active BWP) operated by the target cell may be configured with common search space (e.g., with the field searchSpaceOtherSystemInformaiton), so that the UE may receive the system information on the BWP via the TRP associated with a PCI different from the PCI of the serving cell. After the reception of the RRC Reconfiguration message or after (successfully) performing the action upon reception of SI, the UE may transmit the RRC Reconfiguration Complete message to the TRP associated with a PCI different from the PCI of the serving cell via SRB1 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB.

In one implementation, upon the UE receives the RRC Reconfiguration message via the TRP associated with a PCI different from the PCI of the serving cell, wherein the RRC Reconfiguration message includes the indication for acquisition of SIB1 and/or Other SI, the UE may acquire the SIB1 and/or Other SI as defined in sub-clause 5.2.2.3 in 3GPP TS 38.331, via the TRP associated with a PCI different from the PCI of the serving cell. The UE may not be required to acquire SIB1 and/or Other SI from the serving cell, but still be required to acquire MIB from the serving cell. The BWP (e.g., the initial BWP, the active BWP) operated by the target cell may be configured with common search space (e.g., with the field searchSpaceOtherSystemInformation), so that the UE may receive the SIB1 and/or Other SI on the BWP via the TRP associated with a PCI different from the PCI of the serving cell. After the reception of the RRC Reconfiguration message or after (successfully) performing the action upon reception of SI, the UE may transmit the RRC Reconfiguration Complete message to the TRP associated with a PCI different from the PCI of the serving cell via SRB1 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB.

In Scenario 2: If the UE applies one MAC entity of the UE to process the message/information/signals received from or transmitted to the TRP associated with the PCI of the serving cell and applies another MAC entity of the UE to process the message/information/signals received from or transmitted to the TRP associated with a PCI different from the PCI of the serving cell, the UE may receive the RRC Reconfiguration message including system information (e.g., MIB, SIB1, Other SI) and/or the indication for acquisition of MIB and/or SIB1 and/or the indication for acquisition of SIB1 and/or Other SI, from the TRP associated with a PCI different from the PCI of the serving cell.

In one implementation, the system information (e.g., MIB, SIB1, Other SI) received via the TRP associated with a PCI different from the PCI of the serving cell may be synchronized with or the same as the system information received from the TRP associated with the PCI of the serving cell. That is, the system information may associate with the serving cell. In one implementation, the system information (e.g., MIB, SIB1, Other SI) received via the TRP associated with a PCI different from the PCI of the serving cell may associate with the target cell instead of the serving cell. That is, the system information received via the TRP associated with a PCI different from the PCI of the serving cell may be asynchronized or different from the system information received from the TRP associated with the PCI of the serving cell (or associated with the serving cell).

The UE may not be required to acquire the system information from the serving cell while the UE is receiving RRC reconfiguration including the SI via DL-SCH from the TRP associated with a PCI different from the PCI of the serving cell. The UE may receive the RRC Reconfiguration message via SRB1, SRB3 or a new SRB. The new SRB may be a signaling radio bearer to carry the specific RRC message between the UE and a target cell via a TRP associated with the PCI different from the PCI of the serving cell, e.g., using logical channel DCCH, using transport channel DL-SCH for DL RRC messages and transport channel UL-SCH for UL RRC messages. SRB3 may be a direct signaling radio bearer to carry specific RRC messages between the UE and the secondary node when the UE is in (NG) EN-DC or NR-DC, all using logical channel DCCH.

In one implementation, upon the UE receives the RRC Reconfiguration message including the system information via the TRP associated with a PCI different from the PCI of the serving cell (via SRB1, SRB3 or a new SRB), the UE may perform the action upon reception of System Information as specified in Section 5.2.2.4 in 3GPP TS 38.331. The UE may not be required to acquire the system information from the serving cell. In one implementation, upon the UE receives the RRC Reconfiguration message including the system information via the TRP associated with a PCI different from the PCI of the serving cell (via SRB1, SRB3 or a new SRB), the UE may perform the action upon reception of System Information as specified in Section 5.2.2.4 in 3GPP TS 38.331. If the system information is associated with the serving cell, the UE may not be required to acquire the system information from the serving cell. If the system information is associated with the target cell rather than the serving cell, the UE may still be required to acquire the system information associated with the serving cell, e.g., from the serving cell via non-UE dedicated channels/signals from the TRP associated with the PCI of the serving cell. If the system information is associated with the target cell rather than the serving cell, the UE may still be required to acquire the system information associated with the serving cell, e.g., via UE dedicated channels/signals from the TRP associated with a PCI different from the PCI of the serving cell.

After the reception of the RRC Reconfiguration message or after (successfully) performing the action upon reception of SI, the UE may transmit the RRC Reconfiguration Complete message to the TRP associated with a PCI different from the PCI of the serving cell via SRB1, SRB3 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB. If the UE receives the RRC Reconfiguration message via SRB3, the UE may transmit the RRC Reconfiguration Complete message via SRB3.

In one implementation, upon the UE receives the RRC Reconfiguration message via the TRP associated with a PCI different from the PCI of the serving cell, wherein the RRC Reconfiguration message includes the indication for acquisition of system information associated with the serving cell, the UE may acquire the SI message(s) as defined in sub-clause 5.2.2.3 in 3GPP TS 38.331, via the TRP associated with the PCI of the serving cell. The UE may still be required to acquire the system information from the serving cell. The implementation may be applied when the target cell does not have the same system information as the serving cell, e.g., especially when the target cell and the serving cell are not synchronized or are not operated by the same network node.

After the reception of the RRC Reconfiguration message or after (successfully) performing the action upon reception of SI, the UE may transmit the RRC Reconfiguration Complete message to the TRP associated with a PCI different from the PCI of the serving cell via SRB1, SRB3 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB. If the UE receives the RRC Reconfiguration message via SRB3, the UE may transmit the RRC Reconfiguration Complete message via SRB3. Alternatively, after the reception of the RRC Reconfiguration message or after (successfully) performing the action upon reception of SI, the UE may transmit the RRC Reconfiguration Complete message to the TRP associated with the PCI of the serving cell via SRB1.

In one implementation, upon the UE receives the RRC Reconfiguration message via the TRP associated with a PCI different from the PCI of the serving cell, wherein the RRC Reconfiguration message includes the indication for acquisition of MIB and/or SIB1 associated with the serving cell, the UE may acquire the MIB and/or SIB1 as defined in sub-clause 5.2.2.3 in 3GPP TS 38.331, via the TRP associated with the PCI of the serving cell. The UE may still be required to acquire the MIB and/or SIB1 associated with the serving cell from the serving cell, while the UE may acquire Other SI associated with the serving cell or associated with the target cell from the target cell. This implementation may be applied by the UE especially when the MIB and/or SIB1 associated with the serving cell is the same as the MIB and/or SIB1 associated with the target cell, but not limited to. Thus, the UE may receive the MIB and/or SIB1 via the TRP associated with the PCI of the serving cell via non-UE dedicated channel/signals from the serving cell.

After the reception of the RRC Reconfiguration message or after (successfully) performing the action of acquiring the MIB and/or SIB1 associated with the serving cell, the UE may transmit the RRC Reconfiguration Complete message to the TRP associated with a PCI different from the PCI of the serving cell via SRB1, SRB3 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB. If the UE receives the RRC Reconfiguration message via SRB3, the UE may transmit the RRC Reconfiguration Complete message via SRB3. Alternatively, after the reception of the RRC Reconfiguration message or after (successfully) performing the action of acquiring the MIB and/or SIB1 associated with the serving cell, the UE may transmit the RRC Reconfiguration Complete message to the TRP associated with the PCI of the serving cell via SRB1.

In one implementation, upon the UE receives the RRC Reconfiguration message via the TRP associated with a PCI different from the PCI of the serving cell, wherein the RRC Reconfiguration message includes the indication for acquisition of system information (e.g., MIB, SIB1, or Other SI) associated with the target cell, the UE may acquire the SI message(s) as defined in sub-clause 5.2.2.3 in 3GPP TS 38.331, via the TRP associated with a PCI different from the PCI of the serving cell. The BWP (e.g., the initial BWP, the active BWP) operated by the target cell may be configured with search common space (e.g., with the field searchSpaceOtherSystemInformaiton), so that the UE may receive the system information on the BWP via the TRP associated with a PCI different from the PCI of the serving cell.

After the reception of the RRC Reconfiguration message or after (successfully) performing the action upon reception of SI, the UE may transmit the RRC Reconfiguration Complete message to the TRP associated with a PCI different from the PCI of the serving cell via SRB1, SRB3 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB. If the UE receives the RRC Reconfiguration message via SRB3, the UE may transmit the RRC Reconfiguration Complete message via SRB3.

In one implementation, upon the UE receives the RRC Reconfiguration message via the TRP associated with a PCI different from the PCI of the serving cell, wherein the RRC Reconfiguration message includes the indication for acquisition of SIB1 and/or Other SI associated with the target cell, the UE may acquire the SIB1 and/or Other SI associated with the target cell as defined in sub-clause 5.2.2.3 in 3GPP TS 38.331, via the TRP associated with a PCI different from the PCI of the serving cell. The BWP (e.g., the initial BWP, the active BWP) operated by the target cell may be configured with common search space (e.g., with the field searchSpaceOtherSystemInformaiton), so that the UE may receive the SIB1 and/or Other SI on the BWP via the TRP associated with a PCI different from the PCI of the serving cell. If the SIB1 and/or Other SI associated with the target cell is synchronized with or the same as the SIB1 and/or Other SI associated with the serving cell, the UE may not be required to acquire SIB1 and/or Other SI from the serving cell, but still may be required to acquire MIB associated with the serving cell from the serving cell.

After the reception of the RRC Reconfiguration message or after (successfully) performing the action upon reception of SI, the UE may transmit the RRC Reconfiguration Complete message to the TRP associated with a PCI different from the PCI of the serving cell via SRB1, SRB3 or a new SRB. If the UE receives the RRC Reconfiguration message via SRB1, the UE may transmit the RRC Reconfiguration Complete message via SRB1. If the UE receives the RRC Reconfiguration message via a new SRB, the UE may transmit the RRC Reconfiguration Complete message via the new SRB. If the UE receives the RRC Reconfiguration message via SRB3, the UE may transmit the RRC Reconfiguration Complete message via SRB3.

### System Information Request:

In one implementation, with the UE's request in advance, the UE may receive the Other SI in a dedicated signaling via DCCH on DL-SCH from the TRP associated with a PCI different from the PCI of the serving cell. The details of how the UE receives the Other SI may refer to the implementations in this disclosure, especially in one or more implementations of the Section 1—System Information Reception as described in the preceding paragraphs.

We further propose how the UE requests the system information (e.g., MIB, SIB1, Other SI) before the UE receives the system information. The details of how the UE receives the system information may refer to the implementations in this disclosure, especially in one or more implementations of the Section 1—System Information Reception as described in the preceding paragraphs.

In one implementation, the UE may request the system information without determining a timer (e.g., a prohibit timer related to request the system information) is running or expiry and/or without determining any configuration related to whether the UE is allowed to request the system information is configured to the UE. In one implementation, the UE may request the system information after the UE determines that a timer (e.g., a prohibit timer related to request the system information) expires or is not running. In one implementation, the UE may request the system information after the UE determines that the UE is configured with a configuration related to whether the UE is allowed to request the system information. In one implementation, the UE may request the system information after the UE determines that a timer (e.g., a prohibit timer related to request the system information) expires or is not running and the UE is configured with a configuration related to whether the UE is allowed to request the system information.

In one implementation, the configuration related to whether the UE is allowed to request the system information may include the configuration related to whether the UE is allowed to request the system information when the UE is configured with inter-cell beam management.

In one implementation, the configuration related to whether the UE is allowed to request the system information may include the information of whether the UE is allowed to request the system information of the serving cell (e.g., via any TRP such as a TRP associated with the PCI of the serving cell and a TRP associated with a PCI different from the PCI of the serving cell), information of whether the UE is allowed to request the system information of the target cell (e.g., via any TRP such as a TRP associated with the PCI of the serving cell and a TRP associated with a PCI different from the PCI of the serving cell), and/or information of whether the UE is allowed to request the system information of the target cell from the TRP associated with a PCI different from the PCI of the serving cell.

In one implementation, the UE may receive the configuration related to whether the UE is allowed to request the system information in an RRC message (e.g., RRC Reconfiguration message) from the serving cell (e.g., from the TRP associated with the PCI of the serving cell) or from the target cell (e.g., from the TRP associated with a PCI different from the serving cell). After receiving the configuration related to whether the UE is allowed to request the system information, the UE may configure and/or apply the configuration.

In one implementation, the UE may receive an absent field for the configuration related to whether the UE is allowed to request the system information in an RRC message (e.g., RRC Reconfiguration message) from the serving cell (e.g., from the TRP associated with the PCI of the serving cell) or from the target cell (e.g., from the TRP associated with a PCI different from the serving cell). After receiving the absent field for the configuration related to whether the UE is allowed to request the system information, the UE may release the configuration.

In one implementation, the UE may receive the configuration related to whether the UE is allowed to request the system information in an RRC message (e.g., RRC Release message) from the serving cell (e.g., from the TRP associated with the PCI of the serving cell) or from the target cell (e.g., from the TRP associated with a PCI different from the serving cell). After receiving the configuration related to whether the UE is allowed to request the system information, the UE may release the configuration.

In one implementation, the UE may receive an indicator for the configuration related to whether the UE is allowed to request the system information in an RRC message (e.g., RRC Release message) from the serving cell (e.g., from the TRP associated with the PCI of the serving cell) or from the target cell (e.g., from the TRP associated with a PCI different from the serving cell). After receiving the indicator for the configuration related to whether the UE is allowed to request the system information, the UE may release the configuration.

In one implementation, after the UE receives the requested system information, the UE may release the configuration related to whether the UE is allowed to request the system information.

In one implementation, the prohibit timer related to request the system information may be a timer related to request the system information when the UE is configured with inter-cell beam management. Once the UE requests the system information, the UE may start the timer (i.e., the UE sets the timer value to a configured timer value). When the timer is running, the UE may be prohibited from requesting the system information. Once the UE receives the system information, the UE may stop the timer. Once the timer is not running (e.g., is stopped, or is expiry), the UE may be allowed to request the system information.

In one implementation, the prohibit timer related to request the system information may be a timer related to request the system information associated with the serving cell, especially when the UE is configured with inter-cell beam management, but not limited to. Another prohibit timer related to request the system information may be a timer related to request the system information associated with the target cell, especially when the UE is configured with inter-cell beam management, but not limited to. The UE may operate these two prohibit timers independently. For example, even if the timer related to request the system information associated with the serving cell is running, (and if the timer related to request the system information associated with the target cell is not running, expires, is not configured, and/or stops), the UE may still be allowed to request the system information associated with the target cell.

In one implementation, the UE may receive the configured timer value in an RRC message (e.g., RRC Reconfiguration message) from the serving cell (e.g., from the TRP associated with the PCI of the serving cell) or from the target cell (e.g., from the TRP associated with a PCI different from the PCI of the serving cell). In one implementation, the UE may receive a configured timer value of the prohibit timer related to request the system information associated with the serving cell in an RRC message received from the serving cell (e.g., from the TRP associated with the PCI of the serving cell). In one implementation, the UE may receive a configured timer value of the prohibit timer related to request the system information associated with the target cell in an RRC message received from the target cell (e.g., from the TRP associated with a PCI different from the PCI of the serving cell). In one implementation, there is (only) one configured timer value for both the prohibit timer related to request the system information associated with the serving cell and the prohibit timer related to request the system information associated with the target cell. In one implementation, if a configured timer value of the prohibit timer related to request the system information associated with the target cell is absent, the configured timer value of the prohibit timer related to request the system information associated with the serving cell may be applied for the prohibit timer related to request the system information associated with the target cell. In one implementation, if a configured timer value of the prohibit timer related to request the system information associated with the serving cell is absent, the configured timer value of the prohibit timer related to request the system information associated with the target cell may be applied for the prohibit timer related to request the system information associated with the serving cell.

In one implementation, the configured timer value may be included in the configuration related to whether the UE is allowed to request the system information.

In one implementation, the configured timer value may not be included in the configuration related to whether the UE is allowed to request the system information. However, the configured timer value and the configuration related to whether the UE is allowed to request the system information are included in the same RRC message.

In one implementation, the UE may receive the configured timer value in an RRC message (e.g., RRC Release message) from the serving cell (e.g., from the TRP associated with the PCI of the serving cell) or from the target cell (e.g., from the TRP associated with a PCI different from the serving cell). After receiving the configured timer value, the UE may release the configured timer value.

In one implementation, the UE may receive an indicator for the configured timer value in an RRC message (e.g., RRC Release message) from the serving cell (e.g., from the TRP associated with the PCI of the serving cell) or from the target cell (e.g., from the TRP associated with a PCI different from the serving cell). After receiving the indicator for the configured timer value, the UE may release the configured timer value.

In one implementation, after the UE receives the requested system information, the UE may release the configured timer value.

In one implementation, the system information to be request may be MIB associated with the serving cell, SIB1 associated with the serving cell, Other SI associated with the serving cell, MIB associated with the target cell, SIB1 associated with the target cell, and Other SI associated with the target cell.

In Scenario 1 or when the serving cell and the target cell are associated with the same network node, MIB associated with the serving cell may be the same as MIB associated with the target cell, SIB1 associated with the serving cell may be the same as SIB1 associated with the target cell, and Other SI associated with the serving cell may be the same as Other SI associated with the target cell.

In Scenario 2 or when the serving cell and the target cell are associated with different network nodes, MIB associated with the serving cell may be different from MIB associated with the target cell, SIB1 associated with the serving cell may be different from SIB1 associated with the target cell, and Other SI associated with the serving cell may be different from Other SI associated with the target cell.

In various implementations and conditions, the UE may receive MIB associated with the serving cell via BCCH on BCH from the TRP associated with the PCI of the serving cell, via BCCH on BCH from the TRP associated with a PCI of another cell different from the PCI of the serving cell, via DCCH on DL-SCH from the TRP associated with the PCI of the serving cell, and/or via DCCH on DL-SCH from the TRP associated with a PCI of another cell different from the PCI of the serving cell.

It should be noticed that the terms “TRP associated with a PCI of another cell different from the PCI of the serving cell” and “TRP associated with a PCI different from the PCI of the serving cell” may be used interchangeably.

In various implementations and conditions, the UE may receive MIB associated with the target cell via BCCH on BCH from the TRP associated with the PCI of the serving cell, via BCCH on BCH from the TRP associated with a PCI of another cell different from the PCI of the serving cell, via DCCH on DL-SCH from the TRP associated with the PCI of the serving cell, and/or via DCCH on DL-SCH from the TRP associated with a PCI of another cell different from the PCI of the serving cell.

In various implementations and conditions, the UE may receive SIB1 associated with the serving cell via BCCH on DL-SCH from the TRP associated with the PCI of the serving cell, via BCCH on DL-SCH from the TRP associated with a PCI of another cell different from the PCI of the serving cell, via DCCH on DL-SCH from the TRP associated with the PCI of the serving cell, and/or via DCCH on DL-SCH from the TRP associated with a PCI of another cell different from the PCI of the serving cell.

In various implementations and conditions, the UE may receive SIB1 associated with the target cell via BCCH on DL-SCH from the TRP associated with the PCI of the serving cell, via BCCH on DL-SCH from the TRP associated with a PCI of another cell different from the PCI of the serving cell, via DCCH on DL-SCH from the TRP associated with the PCI of the serving cell, and/or via DCCH on DL-SCH from the TRP associated with a PCI of another cell different from the PCI of the serving cell.

In various implementations and conditions, the UE may receive Other SI associated with the serving cell via BCCH on DL-SCH from the TRP associated with the PCI of the serving cell, via BCCH on DL-SCH from the TRP associated with a PCI of another cell different from the PCI of the serving cell, via DCCH on DL-SCH from the TRP associated with the PCI of the serving cell, and/or via DCCH on DL-SCH from the TRP associated with a PCI of another cell different from the PCI of the serving cell.

In various implementations and conditions, the UE may receive Other SI associated with the target cell via BCCH on DL-SCH from the TRP associated with the PCI of the serving cell, via BCCH on DL-SCH from the TRP associated with a PCI of another cell different from the PCI of the serving cell, via DCCH on DL-SCH from the TRP associated with the PCI of the serving cell, and/or via DCCH on DL-SCH from the TRP associated with a PCI of another cell different from the PCI of the serving cell.

In one implementation, the UE may request the system information by following the implementations in this disclosure if the signal strength of reference signals (e.g., Reference Signal Received Power (RSRP), Reference Signal Received Quality (RSRQ)) associated with the TRP associated with a PCI of another cell different from the PCI of the serving cell is less than or equal to a corresponding threshold. The UE may be preconfigured with the corresponding threshold. Alternatively, the UE may receive an RRC message including the corresponding threshold. It is noted that if the signal strength of reference signals (e.g., Reference Signal Received Power (RSRP), Reference Signal Received Quality (RSRQ)) associated with the TRP associated with a PCI of another cell different from the PCI of the serving cell is less than or equal to a corresponding threshold, the lower layer of the UE (e.g., PHY layer, MAC layer) may indicate to the upper layer of the UE (e.g., RRC layer). Upon receiving the indication from the lower layer of the UE, the upper layer of the UE may trigger the system information request procedure. It is noted that the reference signal may be Synchronization Signal Block (SSB) or CSI-RS.

In one implementation, the UE may request the system information by following the implementations in this disclosure if the signal strength of reference signals (e.g., Reference Signal Received Power (RSRP), Reference Signal Received Quality (RSRQ)) associated with the TRP associated with a PCI of another cell different from the PCI of the serving cell is greater than or equal to a corresponding threshold. It is noted that if the signal strength of reference signals (e.g., Reference Signal Received Power (RSRP), Reference Signal Received Quality (RSRQ)) associated with the TRP associated with a PCI of another cell different from the PCI of the serving cell is greater than or equal to a corresponding threshold, the lower layer of the UE (e.g., PHY layer, MAC layer) may indicate to the upper layer of the UE (e.g., RRC layer). Upon receiving the indication from the lower layer of the UE, the upper layer of the UE may trigger the system information request procedure. It is noted that the reference signal may be SSB or CSI-RS.

In some cases, the UE may request the system information and then receive the requested system information (i.e., the proposed mechanism in this disclosure). The cases include, but are not limited to,
(1) when the UE is in RRC_CONNECTED, and/or
(2) when the UE is configured with inter-cell beam management, and/or
(3) when the UE operates on an active BWP not configured with common search space (CSS) with the field searchSpaceOtherSystemInformation,
(4) when the UE operates on an active BWP (or an initial BWP) not configured with CSS with the field searchSpaceSIB1 and/or
(5) when the UE has not stored a valid version of SIB of one or several required SIB(s), and/or (6) when the UE is requested by the upper layers (e.g., NAS layer of the UE).

It is noted that in case (3), the active BWP not configured with CSS with the field searchSpaceOtherSystemInformation may be associated with the serving cell or the target cell.

### Example 1: The UE Requests Other SI Associated with the Serving Cell

After the UE determines that the UE falls in cases (e.g., especially when the UE has not stored a valid version of SIB of one or several required SIB(s) associated with the serving cell) that the UE can trigger to request the system information and then receive the requested system information, the UE may request the required Other SI associated with the serving cell by transmitting an RRC ICBM SI Request message via UL-SCH to (or via) the TRP associated with a PCI different from the PCI of the serving cell.

According to the system information scheduling information (e.g., si-SchedulingInfo IE) in the UE's stored SIB, for the SI message(s) that include at least one of the UE's required SIB(s) associated with the serving cell, the UE (e.g., the RRC layer of the UE) may include the indication for the required SI message(s) that include at least one of the UE's required SIB(s) and/or include the indication for the UE's required SIB(s) in the RRC ICBM SI Request message. The UE (e.g., the RRC layer of the UE) may then submit the RRC ICBM SI Request message to lower layers (e.g., the MAC layer of the UE) for transmission.

It is noted that the indication for the required SI message(s) that include at least one of the UE's required SIB(s) may be in a form of a list, where an entry of the list may represent a required SI message.

It is noted that the indication for the UE's required SIB(s) may be in a form of a list, where an entry of the list may represent a required SIB.

It is noted, especially in Scenario 1, that the RRC layer of the UE and the MAC layer of the UE may handle the process for the transmission to the TRP associated with the PCI of the serving cell and for the transmission to the TRP associated with a PCI different from the PCI of the serving cell.

It is noted, especially in Scenario 2, that the RRC layer of the UE and the MAC layer of the UE may handle the process for the transmission to the TRP associated with a PCI different from the PCI of the serving cell, even though the requested Other SI is associated with the serving cell.

It is noted, especially in Scenario 2, that the RRC layer of the UE may handle the process for the transmission to the TRP associated with the PCI of the serving cell and for the transmission to the TRP associated with a PCI different from the PCI of the serving cell, while the MAC layer of the UE may handle the process for the transmission to the TRP associated with a PCI different from the PCI of the serving cell.

In one implementation, after the UE (e.g., the RRC layer of the UE) submitting the RRC ICBM SI Request message to lower layers (e.g., the MAC layer of the UE) for transmission, the UE may start the prohibit timer related to request the system information. If the timer is running, the UE cannot transmit another RRC ICBM SI Request message. If the timer is running, the UE cannot request system information, e.g., according to Example 1, 2, 3, and 4, but not limited to. If the UE receives the requested Other SI associated with the serving cell, the UE may stop the timer. If the timer expires and the UE does not receive the requested Other SI associated with the serving cell, the UE may transmit the RRC ICBM SI Request message again.

In one implementation, after the UE (e.g., the RRC layer of the UE) submitting the RRC ICBM SI Request message to lower layers (e.g., the MAC layer of the UE) for transmission, the UE may NOT start the prohibit timer related to request the system information. If the UE triggers to request system information (not limited to associate with the serving cell or the target cell), the UE triggers to request the system information. For example, the UE may transmit another RRC ICBM SI Request message including the requested system information, e.g., according to Examples 1, 2, 3, and 4 but not limited to.

For instance, in Example 1 and considering the implementations for system information reception in this disclosure, the UE may request Other SI associated with the serving cell by transmitting RRC ICBM SI Request message over SRB3 via DCCH in UL-SCH on PUSCH to the TRP associated with the target cell, and acquire the requested Other SI associated with the serving cell by receiving an RRC message over SRB3 via DCCH in DL-SCH on PDSCH from the TRP associated with the target cell.

### Example 2: The UE Requests MIB and/or SIB1 that are Associated with the Serving Cell

After the UE determines that the UE falls in cases that the UE can trigger to request the system information and then receive the requested system information, the UE may request the required MIB and/or SIB1 associated with the serving cell by transmitting an RRC ICBM SI Request message via UL-SCH to the TRP associated with a PCI different from the PCI of the serving cell.

The UE (e.g., the RRC layer of the UE) may include the indication for the required MIB associated with the serving cell and/or include the indication for required SIB1 associated with the serving cell in the RRC ICBM SI Request message. The UE (e.g., the RRC layer of the UE) may then submit the RRC ICBM SI Request message to lower layers (e.g., the MAC layer of the UE) for transmission.

It is noted, especially in Scenario 1, that the RRC layer of the UE and the MAC layer of the UE may handle the process for the transmission to the TRP associated with the PCI of the serving cell and for the transmission to the TRP associated with a PCI different from the PCI of the serving cell.

It is noted, especially in Scenario 2, that the RRC layer of the UE and the MAC layer of the UE may handle the process for the transmission to (and/or the reception from) the TRP associated with a PCI different from the PCI of the serving cell, even though the requested Other SI is associated with the serving cell.

It is noted, especially in Scenario 2, that the RRC layer of the UE may handle the process for the transmission to (and/or the reception from) the TRP associated with the PCI of the serving cell and for the transmission to (and/or the reception from) the TRP associated with a PCI different from the PCI of the serving cell, while the MAC layer of the UE may handle the process for the transmission to the TRP associated with a PCI different from the PCI of the serving cell.

In one implementation, after the UE (e.g., the RRC layer of the UE) submitting the RRC ICBM SI Request message to lower layers (e.g., the MAC layer of the UE) for transmission, the UE may start the prohibit timer related to request the system information. If the timer is running, the UE cannot transmit another RRC ICBM SI Request message. If the timer is running, the UE cannot request system information, e.g., according to Example 1, 2, 3, and 4, but not limited to. If the UE receives the requested MIB and/or SIB1 associated with the serving cell, the UE may stop the timer. If the timer expires and the UE does not receive the requested MIB and/or SIB1 associated with the serving cell, the UE may transmit the RRC ICBM SI Request message again.

In one implementation, after the UE (e.g., the RRC layer of the UE) submitting the RRC ICBM SI Request message to lower layers (e.g., the MAC layer of the UE) for transmission, the UE may NOT start the prohibit timer related to request the system information. If the UE triggers to request system information (not limited to associate with the serving cell or the target cell), the UE triggers to request the system information. For example, the UE may transmit another RRC ICBM SI Request message including the requested system information, e.g., according to Example 1, 2, 3, and 4 but not limited to.

For instance, in Example 2 and considering the implementations for system information reception in this disclosure, the UE may request MIB and/or SIB1 associated with the serving cell by transmitting RRC ICBM SI Request message over SRB3 via DCCH in UL-SCH on PUSCH to the TRP associated with the target cell, and acquire the requested MIB and/or SIB1 associated with the serving cell by receiving an RRC message over SRB3 via DCCH in DL-SCH on PDSCH from the TRP associated with the target cell.

### Example 3: The UE Requests Other SI Associated with the Target Cell

After the UE determines that the UE falls in cases (e.g., especially when the UE has not stored a valid version of SIB of one or several required SIB(s) associated with the target cell) that the UE can trigger to request the system information and then receive the requested system information, the UE may request the required Other SI associated with the target cell by transmitting an RRC ICBM SI Request message via UL-SCH to the TRP associated with a PCI different from the PCI of the serving cell.

According to the system information scheduling information (e.g., si-SchedulingInfo IE) in the UE's stored SIB, for the SI message(s) that include at least one of the UE's required SIB(s) associated with the target cell, the UE (e.g., the RRC layer of the UE) may include the indication for the required SI message(s) that include at least one of the UE's required SIB(s) and/or include the indication for the UE's required SIB(s) in the RRC ICBM SI Request message. The UE (e.g., the RRC layer of the UE) may then submit the RRC ICBM SI Request message to lower layers (e.g., the MAC layer of the UE) for transmission.

It is noted that the indication for the required SI message(s) that include at least one of the UE's required SIB(s) may be in a form of a list, where an entry of the list may represent a required SI message.

It is noted that the indication for the UE's required SIB(s) may be in a form of a list, where an entry of the list may represent a required SIB.

It is noted, especially in Scenario 1, that the RRC layer of the UE and the MAC layer of the UE may handle the process for the transmission to (and/or the reception from) the TRP associated with the PCI of the serving cell and for the transmission to (and/or the reception from) the TRP associated with a PCI different from the PCI of the serving cell.

It is noted, especially in Scenario 2, that the RRC layer of the UE and the MAC layer of the UE may handle the process for the transmission to (and/or the reception from) the TRP associated with a PCI different from the PCI of the serving cell, even though the requested Other SI is associated with the serving cell.

It is noted, especially in Scenario 2, that the RRC layer of the UE may handle the process for the transmission to (and/or the reception from) the TRP associated with the PCI of the serving cell and for the transmission to (and/or the reception from) the TRP associated with a PCI different from the PCI of the serving cell, while the MAC layer of the UE may handle the process for the transmission to (and/or the reception from) the TRP associated with a PCI different from the PCI of the serving cell.

In one implementation, after the UE (e.g., the RRC layer of the UE) submitting the RRC ICBM SI Request message to lower layers (e.g., the MAC layer of the UE) for transmission, the UE may start the prohibit timer related to request the system information. If the timer is running, the UE cannot transmit another RRC ICBM SI Request message. If the timer is running, the UE cannot request system information, e.g., according to Example 1, 2, 3, and 4, but not limited to. If the UE receives the requested Other SI associated with the target cell, the UE may stop the timer. If the timer expires and the UE does not receive the requested Other SI associated with the target cell, the UE may transmit the RRC ICBM SI Request message again.

In one implementation, after the UE (e.g., the RRC layer of the UE) submitting the RRC ICBM SI Request message to lower layers (e.g., the MAC layer of the UE) for transmission, the UE may NOT start the prohibit timer related to request the system information. If the UE triggers to request system information (not limited to associate with the serving cell or the target cell), the UE triggers to request the system information. For example, the UE may transmit another RRC ICBM SI Request message including the requested system information, e.g., according to Example 1, 2, 3, and 4 but not limited to.

For instance, in Example 3 and considering the implementations for system information reception in this disclosure, the UE may request Other SI associated with the target cell by transmitting RRC ICBM SI Request message over SRB3 via DCCH in UL-SCH on PUSCH to the TRP associated with the target cell, and acquire the requested Other SI associated with the target cell by receiving an RRC message over SRB3 via DCCH in DL-SCH on PDSCH from the TRP associated with the target cell.

### Example 4: The UE Requests MIB and/or SIB1 that are Associated with the Target Cell

After the UE determines that the UE falls in cases that the UE can trigger to request the system information and then receive the requested system information, the UE may request the required MIB and/or SIB1 associated with the target cell by transmitting an RRC ICBM SI Request message via UL-SCH to the TRP associated with a PCI different from the PCI of the serving cell.

The UE (e.g., the RRC layer of the UE) may include the indication for the required MIB associated with the target cell and/or include the indication for required SIB1 associated with the target cell in the RRC ICBM SI Request message. The UE (e.g., the RRC layer of the UE) may then submit the RRC ICBM SI Request message to lower layers (e.g., the MAC layer of the UE) for transmission.

It is noted, especially in Scenario 1, that the RRC layer of the UE and the MAC layer of the UE may handle the process for the transmission to (and/or the reception from) the TRP associated with the PCI of the serving cell and for the transmission to (and/or the reception from) the TRP associated with a PCI different from the PCI of the serving cell.

It is noted, especially in Scenario 2, that the RRC layer of the UE and the MAC layer of the UE may handle the process for the transmission to (and/or the reception from) the TRP associated with a PCI different from the PCI of the serving cell, even though the requested Other SI is associated with the serving cell.

It is noted, especially in Scenario 2, that the RRC layer of the UE may handle the process for the transmission to (and/or the reception from) the TRP associated with the PCI of the serving cell and for the transmission to (and/or the reception from) the TRP associated with a PCI different from the PCI of the serving cell, while the MAC layer of the UE may handle the process for the transmission to (and/or the reception from) the TRP associated with a PCI different from the PCI of the serving cell.

In one implementation, after the UE (e.g., the RRC layer of the UE) submitting the RRC ICBM SI Request message to lower layers (e.g., the MAC layer of the UE) for transmission, the UE may start the prohibit timer related to request the system information. If the timer is running, the UE cannot transmit another RRC ICBM SI Request message. If the timer is running, the UE cannot request system information, e.g., according to Example 1, 2, 3, and 4, but not limited to. If the UE receives the requested MIB and/or SIB1 associated with the target cell, the UE may stop the timer. If the timer expires and the UE does not receive the requested MIB and/or SIB1 associated with the target cell, the UE may transmit the RRC ICBM SI Request message again.

In one implementation, after the UE (e.g., the RRC layer of the UE) submitting the RRC ICBM SI Request message to lower layers (e.g., the MAC layer of the UE) for transmission, the UE may NOT start the prohibit timer related to request the system information. If the UE triggers to request system information (not limited to associate with the serving cell or the target cell), the UE triggers to request the system information. For example, the UE may transmit another RRC ICBM SI Request message including the requested system information, e.g., according to Example 1, 2, 3, and 4 but not limited to.

For instance, in Example 4 and considering the implementations for system information reception in this disclosure, the UE may request MIB and/or SIB1 associated with the target cell by transmitting RRC ICBM SI Request message over SRB3 via DCCH in UL-SCH on PUSCH to the TRP associated with the target cell, and acquire the requested MIB and/or SIB1 associated with the target cell by receiving an RRC message over SRB3 via DCCH in DL-SCH on PDSCH from the TRP associated with the target cell.

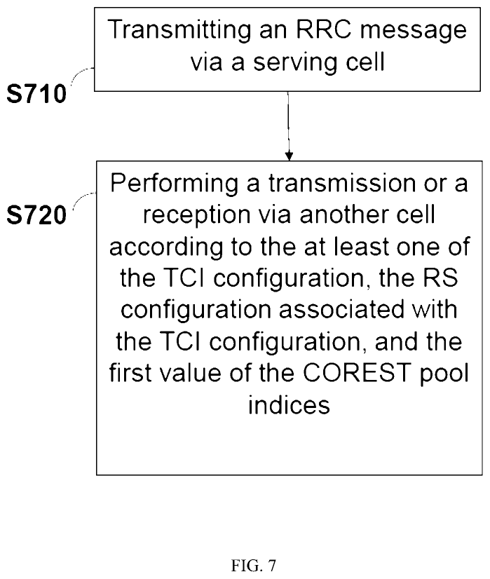

FIG. 7 is a flow chart of a method adapted for a network device according to an exemplary embodiment of the present disclosure. Referring to FIG. 7, note that the order of the steps in this Figure may be changed according to the actual requirements.

Step S710: a network device transmits a radio resource control (RRC) message to a UE via a serving cell. The RRC message comprises first information of at least one of a transmission configuration indicator (TCI) configuration, a reference signal (RS) configuration associated with the TCI configuration, and a first value of control resource set (CORESET) pool indices, and the first information is associated with another cell with a second physical cell identity (PCI) different from a first PCI of the serving cell.

Step S720: the network device performs a transmission or a reception via the another cell according to the at least one of the TCI configuration, the RS configuration associated with the TCI configuration, and the first value of the CORESET pool indices.

In one implementation, the RRC message may further include second information of at least one of a second TCI configuration, a second RS configuration associated with the second TCI configuration, and a second value of the CORESET pool indices, and the second information is associated with the serving cell.

In one implementation, the first value of the CORESET pool indices in the first information is different from the second value of the CORESET pool indices in the second information.

In one implementation, the first value of the CORESET pool indices is associated with the TCI configuration.

In one implementation, the TCI configuration is at least one of: a downlink TCI configuration related to a list of TCI states configured for downlink reception, an uplink TCI configuration related to a list of TCI states configured for uplink transmission, and a joint configuration related to a list of TCI states configured for the downlink reception and the uplink transmission.

In one implementation, a network device may perform an inter-cell physical downlink shared channel (PDSCH) transmission to transmit PDSCH via a TRP associated with a PCI of another cell different from the PCI of the serving cell, perform an inter-cell physical downlink control channel (PDCCH) transmission to transmit PDCCH via a TRP associated with a PCI of another cell different from the PCI of the serving cell, perform an inter-cell downlink reference signal transmission via a TRP associated with a PCI of another cell different from the PCI of the serving cell, perform an inter-cell physical uplink shared channel (PUSCH) reception to receive PUSCH via a TRP associated with a PCI of another cell different from the PCI of the serving cell, perform an inter-cell physical uplink control channel (PUCCH) reception to receive PUCCH via a TRP associated with a PCI of another cell different from the PCI of the serving cell, or perform an inter-cell uplink reference signal transmission via a TRP associated with a PCI of another cell different from the PCI of the serving cell. The downlink reference signal comprises DeModulation Reference Signal (DMRS) and Channel State Information Reference Signal (CSI-RS). The uplink reference signal comprises Sounding Reference Signal (SRS).

In one implementation, a network device may transmit a UE capability enquiry message, and receive a UE capability information message in response to transmitting the UE capability enquiry message. The UE capability information message comprises a capability of performing the transmission or the reception according to the applied configuration from at least one of the TCI configuration, the RS configuration associated with the TCI configuration, and the first value of the CORESET pool indices.

In one implementation, a network device may receive or transmit a UE-dedicated channel or a UE-dedicated signal via a TRP associated with a PCI of another cell different from the PCI of the serving cell, and receive or transmit a non-UE-dedicated channel or a non-UE-dedicated signal via the serving cell. The UE-dedicated channel or the UE-dedicated signal is message, signal or information via a logical channel which is one of dedicated control channel (DCCH) and dedicated traffic channel (DTCH), the UE-dedicated channel or the UE-dedicated signal is message, signal or information via one of PDCCH and PUCCH, and/or the non-UE-dedicated channel or the non-UE-dedicated signal is message, signal or information via a logical channel which is one of broadcast control channel (BCCH), paging control channel (PCCH), and common control channel (CCCH).

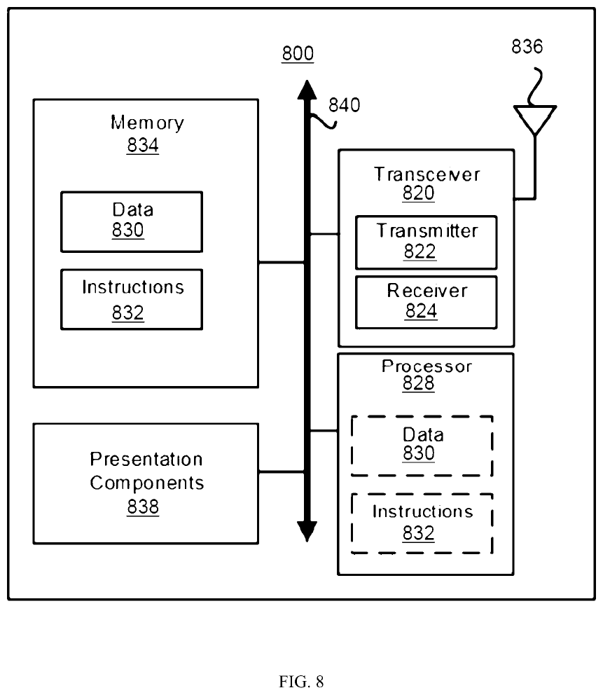

FIG. 8 illustrates a block diagram of a node for wireless communication, in accordance with various aspects of the present application. As shown in FIG. 8, a node 800 may include a transceiver 820, a processor 828, a memory 834, one or more presentation components 838, and at least one antenna 836. The node 800 may also include an RF spectrum band module, a base station communications module, a network communications module, and a system communications management module, Input/Output (I/O) ports, I/O components, and power supply (not explicitly shown in FIG. 8). Each of these components may be in communication with each other, directly or indirectly, over one or more buses 840. In one implementation, the node 800 may be a UE or a base station that performs various functions described herein, for example, with reference to FIGS. 1 through 7.

The transceiver 820 having a transmitter 822 (e.g., transmitting/transmission circuitry) and a receiver 824 (e.g., receiving/reception circuitry) may be configured to transmit and/or receive time and/or frequency resource partitioning information. In some implementations, the transceiver 820 may be configured to transmit in different types of subframes and slots including, but not limited to, usable, non-usable and flexibly usable subframes and slot formats. The transceiver 820 may be configured to receive data and control channels.

The node 800 may include a variety of computer-readable media. Computer-readable media can be any available media that can be accessed by the node 800 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 834 may include computer-storage media in the form of volatile and/or non-volatile memory. The memory 834 may be removable, non-removable, or a combination thereof. Exemplary memory includes solid-state memory, hard drives, optical-disc drives, etc. As illustrated in FIG. 8, The memory 834 may store computer-readable, computer-executable instructions 832 (e.g., software codes) that are configured to, when executed, cause the processor 828 to perform various functions described herein, for example, with reference to FIGS. 1 through 7. Alternatively, the instructions 832 may not be directly executable by the processor 828 but be configured to cause the node 800 (e.g., when compiled and executed) to perform various functions described herein.

The processor 828 (e.g., having processing circuitry) may include an intelligent hardware device, e.g., a Central Processing Unit (CPU), a microcontroller, an ASIC, etc. The processor 828 may include memory. The processor 828 may process the data 830 and the instructions 832 received from the memory 834, and information through the transceiver 820, the base band communications module, and/or the network communications module. The processor 828 may also process information to be sent to the transceiver 820 for transmission through the antenna 836, to the network communications module for transmission to a core network.

One or more presentation components 838 presents data indications to a person or other device. Exemplary presentation components 838 include a display device, speaker, printing component, vibrating component, etc.

From the above description, it is manifested that various techniques may be used for implementing the concepts described in the present application without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A method for an inter-cell beam operation, adapted by a user equipment (UE), the method comprising:
receiving a radio resource control (RRC) message from a first cell, the RRC message comprising first information including at least one of a transmission configuration indicator (TCI) configuration, a reference signal (RS) configuration associated with the TCI configuration, and a first value of control resource set (CORESET) pool indices, wherein the first information is associated with a second cell having a second physical cell identity (PCI) that is different from a first PCI of the first cell; and
applying at least one of the TCI configuration, the RS configuration associated with the TCI configuration, and the first value of the CORESET pool indices to perform a transmission to or a reception from the second cell.

2-10. (canceled)

11. A user equipment (UE) comprising:
a transceiver;
at least one processor; and
at least one non-transitory computer-readable medium coupled to the at least one processor and storing one or more computer-executable instructions that, when executed by the at least one processor, cause the UE to:
receive, through the transceiver, a radio resource control (RRC) message from a first cell, the RRC message comprising first information including at least one of a transmission configuration indicator (TCI) configuration, a reference signal (RS) configuration associated with the TCI configuration, and a first value of control resource set (CORESET) pool indices, wherein the first information is associated with a second cell having a second physical cell identity (PCI) that is different from a first PCI of the first cell, and
apply at least one of the TCI configuration, the RS configuration associated with the TCI configuration, and the first value of the CORESET pool indices to perform, through the transceiver, a transmission to or a reception from the second cell.

12. The UE of claim 11, wherein;
the RRC message further comprises second information including at least one of a second TCI configuration, a second RS configuration associated with the second TCI configuration, and a second value of the CORESET pool indices, and
the second information is associated with the first cell.

13. The UE of claim 12, wherein the first value of the CORESET pool indices in the first information is different from the second value of the CORESET pool indices in the second information.

14. The UE of claim 11, wherein the first value of the CORESET pool indices is associated with the TCI configuration.

15. The UE of claim 11, wherein the TCI configuration comprises at least one of:
a downlink TCI configuration related to a first list of TCI states configured for a downlink reception,
an uplink TCI configuration related to a second list of TCI states configured for an uplink transmission, and
a joint TCI configuration related to a third list of TCI states configured for the downlink reception and the uplink transmission.

16. The UE of claim 11, wherein the one or more computer-executable instructions, when executed by the at least one processor, further cause the UE to:
add the TCI configuration in response to receiving information indicating that the TCI configuration is to be added, or
modify the TCI configuration in response to receiving information indicating that the TCI configuration is to be modified, or
store the TCI configuration in response to adding or modifying the TCI configuration, or
release the TCI configuration in response to receiving information indicating that the TCI configuration is to be released.

17. The UE of claim 11, wherein the one or more computer-executable instructions, when executed by the at least one processor, further cause the UE to:
perform an inter-cell physical downlink shared channel (PDSCH) reception to receive a PDSCH from the second cell, or
perform an inter-cell physical downlink control channel (PDCCH) reception to receive a PDCCH from the second cell, or
perform an inter-cell downlink reference signal reception from the second cell, or
perform an inter-cell physical uplink shared channel (PUSCH) transmission to transmit a PUSCH to the second cell, or
perform an inter-cell physical uplink control channel (PUCCH) transmission to transmit a PUCCH to the second cell, or
perform an inter-cell uplink reference signal transmission to the second cell, wherein:
a downlink reference signal received in the inter-cell downlink reference signal reception comprises a DeModulation Reference Signal (DMRS) and a Channel State Information Reference Signal (CSI-RS, and
an uplink reference signal transmitted in the inter-cell uplink reference signal transmission comprises a Sounding Reference Signal (SRS).

18. The UE of claim 11, wherein the one or more computer-executable instructions, when executed by the at least one processor, further cause the UE to:
receive, through the transceiver, a UE capability enquiry message; and
transmit, through the transceiver, a UE capability information message in response to receiving the UE capability enquiry message, wherein the UE capability information message comprises a capability of performing the transmission or the reception with the second cell according to the at least one of the TCI configuration, the RS configuration associated with the TCI configuration, and the first value of the CORESET pool indices; or
the one or more computer-executable instructions, when executed by the at least one processor, further cause the UE to:
be preconfigured with a capability of performing the transmission or the reception with the second cell according to the at least one of the TCI configuration, the RS configuration associated with the TCI configuration, and the first value of the CORESET pool indices.

19. The UE of claim 11, wherein the one or more computer-executable instructions, when executed by the at least one processor, further cause the UE to:
receive or transmit, through the transceiver, a UE-dedicated channel or a UE-dedicated signal via the second cell; and
receive or transmit, through the transceiver, a non-UE-dedicated channel or a non-UE-dedicated signal via the second cell, wherein:
the UE-dedicated channel or the UE-dedicated signal comprises a message, a signal, or information carried via a logical channel which is one of a dedicated control channel (DCCH) and a dedicated traffic channel (DTCH), or
the UE-dedicated channel or the UE-dedicated signal comprises a message, a signal, or information carried via one of a PDCCH and a PUCCH, or
the non-UE-dedicated channel or the non-UE-dedicated signal comprises a message, a signal, or information carried via a logical channel which is one of a broadcast control channel (BCCH), a paging control channel (PCCH), and a common control channel (CCCH).

20. A network device comprising:
at least one transceiver;
at least one processor; and
at least one non-transitory computer-readable medium coupled to the at least one processor and storing one or more computer-executable instructions that, when executed by the at least one processor, cause the network device to:
transmit, through the transceiver, a radio resource control (RRC) message via a first cell to a User Equipment (UE), the RRC message comprising first information including at least one of a transmission configuration indicator (TCI) configuration, a reference signal (RS) configuration associated with the TCI configuration, and a first value of control resource set (CORESET) pool indices, and the first information is associated with a second cell with a second physical cell identity (PCI) that is different from a first PCI of the first cell; and
perform, through the transceiver, a transmission or a reception via the second cell according to at least one of the TCI configuration, the RS configuration associated with the TCI configuration, and the first value of the CORESET pool indices.

21. The network device of claim 20, wherein:
the RRC message further comprises second information including at least one of a second TCI configuration, a second RS configuration associated with the second TCI configuration, and a second value of the CORESET pool indices, and
the second information is associated with the first cell.

22. The network device of claim 21, wherein the first value of the CORESET pool indices in the first information is different from the second value of the CORESET pool indices in the second information.

23. The network device of claim 20, wherein the first value of the CORESET pool indices is associated with the TCI configuration.

24. The network device of claim 20, wherein the TCI configuration comprises at least one of:
a downlink TCI configuration related to a first list of TCI states configured for a downlink reception,
an uplink TCI configuration related to a second list of TCI states configured for an uplink transmission, and
a joint TCI configuration related to a third list of TCI states configured for the downlink reception and the uplink transmission.
